(19) United States
(12) Patent Application Publication
(10) Pub. No.: US 2025/0105991 A1
(43) Pub. Date: Mar. 27, 2025

(54) COMMUNICATIONS BY A SUBBAND FULL DUPLEX CAPABLE USER EQUIPMENT IN A HALF DUPLEX CELL MODE

(71) Applicant: QUALCOMM Incorporated, San Diego, CA (US)

(72) Inventors: Qian ZHANG, Basking Ridge, NJ (US); Junyi LI, Fairless Hills, PA (US); Yan ZHOU, San Diego, CA (US)

(21) Appl. No.: 18/472,899

(22) Filed: Sep. 22, 2023

(51) Int. Cl. H04L 5/14

(52) U.S. Cl. CPC H04L 5/14

(57) ABSTRACT

Methods, systems, and devices for wireless communications are described. A network may configure a user equipment (UE) with a time duration pattern, and may further indicate (e.g., via control signaling) which time intervals (e.g., slots or symbols) of the time duration pattern are designated as full duplex time intervals. The network may indicate a full duplex time interval on a configured downlink symbol, a configured uplink symbol, or a configured flexible symbol. The network may further indicate frequency resources (e.g., an uplink subband, a downlink subband, etc.) via which the UE is to perform the full duplex communication during the indicated time intervals. The control signaling may include an indication of a full duplex mode for each of the time intervals. Multiple transmission receive points (TRPs) may communicate to determining which TRP will schedule uplink signaling and which TRP will schedule downlink signaling in the full duplex time interval.

### FIELD OF TECHNOLOGY

The following relates to wireless communications, including communications by a subband full duplex capable user equipment (UE) in a half duplex cell mode.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support communications by a subband full duplex capable user equipment (UE) in a half duplex cell mode. For example, the described techniques provide for a network which may configure the UE with the time duration pattern, and may further indicate (e.g., via control signaling) which time intervals (e.g., slots or symbols) of the time duration pattern are designated as full duplex time intervals. Specifically, the network may indicate a full duplex time interval on a legacy downlink symbol, a legacy uplink symbol, or a legacy flexible symbol. The network may further indicate frequency resources (e.g., an uplink subband, a downlink subband, etc.) via which the UE is to perform the full duplex communication during the indicated time intervals. In some examples, the control signaling may include an indication of a full duplex mode for each of the time intervals (e.g., an control message, such as a radio resource control (RRC) message may indicate a 1 for a full duplex mode and a 0 for a another communication mode such as a half duplex mode). In some examples, multiple transmission receive points (TRPs) may communicate (e.g., via backhaul signaling or over the air signaling), to determining which TRP will schedule uplink signaling and which TRP will schedule downlink signaling in the full duplex time interval. In such examples, the configuration of the time duration patterns and/or the frequency resources may include an indication of a cell identifier (ID) corresponding to each cell (e.g., a cell ID for a set of uplink resources and a cell ID for a set of downlink resources, such that the UE can communicate via uplink and downlink signaling with the respective TRPs).

A method for wireless communications by a user equipment (UE) is described. The method may include receiving first control signaling including an indication of a time duration pattern for wireless communication with a network via a set of multiple time intervals, the set of multiple time intervals including a first set of downlink time intervals, a second set of uplink time intervals, a third set of flexible time intervals, or any combination thereof, receiving second control signaling designating one or more time intervals of the set of multiple time intervals for wireless communications by the UE according to a full duplex mode supported by the UE, and simultaneously transmitting uplink signaling and receiving downlink signaling via the one or more time intervals of the set of multiple time intervals according to the indication and according to the full duplex mode.

A UE for wireless communications is described. The UE may include one or more memories storing processor executable code, and one or more processors coupled with the one or more memories. The one or more processors may individually or collectively operable to execute the code to cause the UE to receive first control signaling including an indication of a time duration pattern for wireless communication with a network via a set of multiple time intervals, the set of multiple time intervals including a first set of downlink time intervals, a second set of uplink time intervals, a third set of flexible time intervals, or any combination thereof, receive second control signaling designating one or more time intervals of the set of multiple time intervals for wireless communications by the UE according to a full duplex mode supported by the UE, and simultaneously transmit uplink signaling and receiving downlink signaling via the one or more time intervals of the set of multiple time intervals according to the indication and according to the full duplex mode.

Another UE for wireless communications is described. The UE may include means for receiving first control signaling including an indication of a time duration pattern for wireless communication with a network via a set of multiple time intervals, the set of multiple time intervals including a first set of downlink time intervals, a second set of uplink time intervals, a third set of flexible time intervals, or any combination thereof, means for receiving second control signaling designating one or more time intervals of the set of multiple time intervals for wireless communications by the UE according to a full duplex mode supported by the UE, and means for simultaneously transmitting uplink signaling and receiving downlink signaling via the one or more time intervals of the set of multiple time intervals according to the indication and according to the full duplex mode.

A non-transitory computer-readable medium storing code for wireless communications is described. The code may include instructions executable by a processor to receive first control signaling including an indication of a time duration pattern for wireless communication with a network via a set of multiple time intervals, the set of multiple time intervals including a first set of downlink time intervals, a second set of uplink time intervals, a third set of flexible time intervals, or any combination thereof, receive second control signaling designating one or more time intervals of the set of multiple time intervals for wireless communications by the UE according to a full duplex mode supported by the UE, and simultaneously transmit uplink signaling and receiving downlink signaling via the one or more time intervals of the set of multiple time intervals according to the indication and according to the full duplex mode.

Some examples of the method, user equipment (UEs), and non-transitory computer-readable medium described herein may further include operations, features, means, or instructions for receiving, via the second control signaling, an indication of at least one uplink subband for the uplink signaling and at least one downlink subband for the downlink signaling corresponding to the one or more time intervals according to the full duplex mode, where transmitting the uplink signaling via the one or more time intervals may be based on the indication of the at least one uplink subband, and receiving the downlink signaling via the one or more time intervals may be based on the indication of the at least one downlink subband.

In some examples of the method, user equipment (UEs), and non-transitory computer-readable medium described herein, the second control signaling designates one or more downlink time intervals of the first set of downlink time intervals for the wireless communications by the UE according to the full duplex mode, and where the uplink signaling may be transmitted via the at least one uplink subband during the designated one or more downlink time intervals and the downlink signaling may be received via the at least one downlink subband during the designated one or more uplink time intervals.

In some examples of the method, user equipment (UEs), and non-transitory computer-readable medium described herein, the second control signaling designates one or more uplink time intervals of the second set of uplink time intervals for the wireless communications by the UE according to the full duplex mode, and where the uplink signaling may be transmitted via the at least one uplink subband during the designated one or more uplink time intervals and the downlink signaling may be received via the at least one downlink subband during the designated one or more downlink time intervals.

In some examples of the method, user equipment (UEs), and non-transitory computer-readable medium described herein, the second control signaling designates one or more flexible time intervals of the third set of flexible time intervals for the wireless communications by the UE according to the full duplex mode, and where the uplink signaling may be transmitted via the at least one uplink subband during the designated one or more flexible time intervals and the downlink signaling may be received via the at least one downlink subband during the designated one or more flexible time intervals.

In some examples of the method, user equipment (UEs), and non-transitory computer-readable medium described herein, the full duplex mode supported by the UE includes a subband full duplex mode, or a partially overlapping full duplex mode, and where receiving the indication of the at least one uplink subband and the at least one downlink subband may be based on the subband full duplex mode or the partially overlapping full duplex mode supported by the UE.

Some examples of the method, user equipment (UEs), and non-transitory computer-readable medium described herein may further include operations, features, means, or instructions for receiving, via the first control signaling, a first portion of the time duration pattern corresponding to a first cell or a first transmission reception point and a second portion of the time duration pattern corresponding to a second cell or a second transmission reception point and receiving, via the second control signaling, an indication of at least one uplink subband for the uplink signaling and at least one downlink subband for the downlink signaling corresponding to the one or more time intervals according to the full duplex mode.

In some examples of the method, user equipment (UEs), and non-transitory computer-readable medium described herein, transmitting the uplink signaling and receiving the downlink signaling may include operations, features, means, or instructions for transmitting the uplink signaling via the one or more time intervals to the first cell or the first transmission reception point according to the first portion of the time duration pattern and receiving the downlink signaling via the one or more time intervals from the second cell or the second transmission reception point according to the second portion of the time duration pattern.

In some examples of the method, user equipment (UEs), and non-transitory computer-readable medium described herein, the first cell or the first transmission reception point may be associated with a first component carrier of a carrier aggregation mode, and the second cell or the second transmission reception point may be associated with a second component carrier of the carrier aggregation mode.

Some examples of the method, user equipment (UEs), and non-transitory computer-readable medium described herein may further include operations, features, means, or instructions for receiving, via the second control signaling, an indication that the full duplex mode applies to each of the one or more time intervals in a UE supported full duplex mode.

Some examples of the method, user equipment (UEs), and non-transitory computer-readable medium described herein may further include operations, features, means, or instructions for receiving a control message, where a first set of fields of the control message includes the first control signaling and a second set of fields of the control message includes the second control signaling.

Some examples of the method, user equipment (UEs), and non-transitory computer-readable medium described herein may further include operations, features, means, or instructions for receiving a first control message including the first control signaling and receiving a second control message including the second control signaling.

Some examples of the method, user equipment (UEs), and non-transitory computer-readable medium described herein may further include operations, features, means, or instructions for transmitting capability information including an indication that the UE supports the full duplex mode at the UE side, where receiving the second control signaling may be based on the capability information.

A method for wireless communications by a network entity is described. The method may include transmitting first control signaling including an indication of a time duration pattern for wireless communication with a UE via a set of multiple time intervals, the set of multiple time intervals including a first set of downlink time intervals, a second set of uplink time intervals, a third set of flexible time intervals, or any combination thereof, transmitting second control signaling designating one or more time intervals of the set of multiple time intervals for wireless communications by the UE according to a full duplex mode supported by the UE, and receiving uplink signaling, or transmitting downlink signaling, or both simultaneously, via the one or more time intervals of the set of multiple time intervals according to the indication and according to the full duplex mode supported by the UE.

A network entity for wireless communications is described. The network entity may include one or more memories storing processor executable code, and one or more processors coupled with the one or more memories. The one or more processors may individually or collectively operable to execute the code to cause the network entity to transmit first control signaling including an indication of a time duration pattern for wireless communication with a UE via a set of multiple time intervals, the set of multiple time intervals including a first set of downlink time intervals, a second set of uplink time intervals, a third set of flexible time intervals, or any combination thereof, transmit second control signaling designating one or more time intervals of the set of multiple time intervals for wireless communications by the UE according to a full duplex mode supported by the UE, and receive uplink signaling, or transmitting downlink signaling, or both simultaneously, via the one or more time intervals of the set of multiple time intervals according to the indication and according to the full duplex mode supported by the UE.

Another network entity for wireless communications is described. The network entity may include means for transmitting first control signaling including an indication of a time duration pattern for wireless communication with a UE via a set of multiple time intervals, the set of multiple time intervals including a first set of downlink time intervals, a second set of uplink time intervals, a third set of flexible time intervals, or any combination thereof, means for transmitting second control signaling designating one or more time intervals of the set of multiple time intervals for wireless communications by the UE according to a full duplex mode supported by the UE, and means for receiving uplink signaling, or transmitting downlink signaling, or both simultaneously, via the one or more time intervals of the set of multiple time intervals according to the indication and according to the full duplex mode supported by the UE.

A non-transitory computer-readable medium storing code for wireless communications is described. The code may include instructions executable by a processor to transmit first control signaling including an indication of a time duration pattern for wireless communication with a UE via a set of multiple time intervals, the set of multiple time intervals including a first set of downlink time intervals, a second set of uplink time intervals, a third set of flexible time intervals, or any combination thereof, transmit second control signaling designating one or more time intervals of the set of multiple time intervals for wireless communications by the UE according to a full duplex mode supported by the UE, and receive uplink signaling, or transmitting downlink signaling, or both simultaneously, via the one or more time intervals of the set of multiple time intervals according to the indication and according to the full duplex mode supported by the UE.

Some examples of the method, network entities, and non-transitory computer-readable medium described herein may further include operations, features, means, or instructions for transmitting, via the second control signaling, an indication of at least one uplink subband and at least one downlink subband corresponding to the one or more time intervals according to the full duplex mode, where receiving the uplink signaling via the one or more time intervals may be based on the indication of the at least one uplink subband, or transmitting the downlink signaling via the one or more time intervals may be based on the indication of the at least one downlink subband.

In some examples of the method, network entities, and non-transitory computer-readable medium described herein, the second control signaling designates one or more uplink time intervals of the second set of uplink time intervals for the wireless communications by the UE according to the full duplex mode, and where the uplink signaling may be transmitted via the at least one uplink subband during the designated one or more uplink time intervals and the downlink signaling may be received via the at least one downlink subband during the designated one or more downlink time intervals.

In some examples of the method, network entities, and non-transitory computer-readable medium described herein, the second control signaling designates one or more downlink time intervals of the first set of downlink time intervals for the wireless communications by the UE according to the full duplex mode, and where the uplink signaling may be transmitted via the at least one uplink subband during the designated one or more downlink time intervals and the downlink signaling may be received via the at least one downlink subband during the designated one or more uplink time intervals.

In some examples of the method, network entities, and non-transitory computer-readable medium described herein, the second control signaling designates one or more flexible time intervals of the third set of flexible time intervals for the wireless communications by the UE according to the full duplex mode, and where the uplink signaling may be transmitted via the at least one uplink subband during the designated one or more flexible time intervals and the downlink signaling may be received via the at least one downlink subband during the designated one or more flexible time intervals.

In some examples of the method, network entities, and non-transitory computer-readable medium described herein, the full duplex mode supported by the UE includes a subband full duplex mode, or a partially overlapping full duplex mode, and where receiving the indication of the at least one uplink subband and the at least one downlink subband may be based on the subband full duplex mode or the partially overlapping full duplex mode supported by the UE.

Some examples of the method, network entities, and non-transitory computer-readable medium described herein may further include operations, features, means, or instructions for transmitting, via a communication link, a message to a second network entity indicating at least one time interval of the one or more time intervals, a directionality of the one or more time intervals, a first set of one or more frequency resources for the full duplex operation, or a combination thereof, per cell of a set of multiple cells, per component carrier of a set of multiple component carriers, per distributed unit of a set of multiple distributed units, per central unit of a set of multiple central units, or any combination thereof, receiving, via the communication link from the second network entity, a second message indicating at least a second time interval, a second directionality of the at least second time interval, a second set of one or more frequency resources for the full duplex operation, or a combination thereof, per cell of the set of multiple cells, per component carrier of the set of multiple component carriers, per distributed unit of the set of multiple distributed units, per central unit of the set of multiple central units, or any combination thereof, and transmitting, via the second control signaling, an indication that the one or more time intervals correspond to the uplink signaling or the downlink signaling based on the message, the second message, or both.

In some examples of the method, network entities, and non-transitory computer-readable medium described herein, the communication link includes a backhaul link or an over-the-air link.

Some examples of the method, network entities, and non-transitory computer-readable medium described herein may further include operations, features, means, or instructions for transmitting, via the first control signaling, a first portion of the time duration pattern corresponding to a first cell or a first transmission reception point and a second portion of the time duration pattern corresponding to a second cell or a second transmission reception point and transmitting, via the second control signaling, an indication of at least one uplink subband for the uplink signaling and at least one downlink subband for the downlink signaling corresponding to the one or more time intervals according to the full duplex mode.

In some examples of the method, network entities, and non-transitory computer-readable medium described herein, simultaneously receiving the uplink signaling and transmitting the downlink signaling may include operations, features, means, or instructions for receiving the uplink signaling via the one or more time intervals according to the first portion of the time duration pattern and transmitting the downlink signaling via the one or more time intervals according to the second portion of the time duration pattern.

In some examples of the method, network entities, and non-transitory computer-readable medium described herein, the first network entity may be associated with a first component carrier of a carrier aggregation mode, and the second network entity may be associated with a second component carrier of the carrier aggregation mode.

Some examples of the method, network entities, and non-transitory computer-readable medium described herein may further include operations, features, means, or instructions for transmitting, via the second control signaling, an indication that the full duplex mode applies to each of the one or more time intervals in a UE supported full duplex mode.

Some examples of the method, network entities, and non-transitory computer-readable medium described herein may further include operations, features, means, or instructions for transmitting a control message, where a first set of fields of the control message includes the first control signaling and a second set of fields of the control message includes the second control signaling.

Some examples of the method, network entities, and non-transitory computer-readable medium described herein may further include operations, features, means, or instructions for transmitting a first control message including the first control signaling and transmitting a second control message including the second control signaling.

Some examples of the method, network entities, and non-transitory computer-readable medium described herein may further include operations, features, means, or instructions for receiving capability information including an indication that the UE supports the full duplex mode, where transmitting the second control signaling may be based on the capability information.

### BRIEF DESCRIPTION OF THE DRAWINGS

FIG. 1 shows an example of a wireless communications system that supports communications by a subband full duplex capable user equipment in a half duplex cell mode in accordance with one or more aspects of the present disclosure.

FIG. 2 shows an example of a wireless communications system that supports communications by a subband full duplex capable user equipment in a half duplex cell mode in accordance with one or more aspects of the present disclosure.

FIG. 3 shows an example of a wireless scheme system that supports communications by a subband full duplex capable user equipment in a half duplex cell mode in accordance with one or more aspects of the present disclosure.

FIG. 4 shows an example of a wireless communications scheme that supports communications by a subband full duplex capable user equipment in a half duplex cell mode in accordance with one or more aspects of the present disclosure.

FIG. 5 shows an example of a process flow that supports communications by a subband full duplex capable user equipment in a half duplex cell mode in accordance with one or more aspects of the present disclosure.

FIGS. 6 and 7 show block diagrams of devices that support communications by a subband full duplex capable user equipment in a half duplex cell mode in accordance with one or more aspects of the present disclosure.

FIG. 8 shows a block diagram of a communications manager that supports communications by a subband full duplex capable user equipment in a half duplex cell mode in accordance with one or more aspects of the present disclosure.

FIG. 9 shows a diagram of a system including a device that supports communications by a subband full duplex capable user equipment in a half duplex cell mode in accordance with one or more aspects of the present disclosure.

FIGS. 10 and 11 show block diagrams of devices that support communications by a subband full duplex capable user equipment in a half duplex cell mode in accordance with one or more aspects of the present disclosure.

FIG. 12 shows a block diagram of a communications manager that supports communications by a subband full duplex capable user equipment in a half duplex cell mode in accordance with one or more aspects of the present disclosure.

FIG. 13 shows a diagram of a system including a device that supports communications by a subband full duplex capable user equipment in a half duplex cell mode in accordance with one or more aspects of the present disclosure.

FIGS. 14 through 17 show flowcharts illustrating methods that support communications by a subband full duplex capable user equipment in a half duplex cell mode in accordance with one or more aspects of the present disclosure.

### DETAILED DESCRIPTION

Some wireless devices in a wireless communications system may support full duplex operations (e.g., such as subband full duplex (SBFD) operations). When performing full duplex operations, a wireless device may simultaneously receive and transmit (e.g., in a partially or fully overlapping time resource). Full duplex operations may increase throughput, and more efficiently make use of available system resources. For example, a network entity may support SBFD operations, and may communicate uplink and downlink signaling simultaneously (e.g., with two UEs, one transmitting and one receiving). In some examples, a user equipment (UE) may support SBFD operations (e.g., may simultaneously transmit uplink signaling and receive downlink signaling).

In some examples, the UE may support the SBFD operation communicating with a single network entity (e.g., that also supports SBFD operations), or with multiple transmission/reception points (TRPs) (e.g., the SBFD capable UE may simultaneously transmit uplink signaling to a first TRP operating in a half-duplex mode, and receive downlink signaling from another TRP operating in a half-duplex mode). However, some wireless communications systems do not support a SBFD UE (e.g., which may be configured by one or more half-duplex TRPs) communicating via downlink, uplink, or flexible symbols. For instance, the UE may be configured with a time duration pattern (e.g., a pattern of uplink, downlink, or flexible symbols), but may not have a mechanism by which to determine resource in which to perform SBFD communications (e.g., even though the UE is capable of full duplex operations). Without an indication of resources, the UE may not be able to perform the SBFD communications, resulting in inefficient use of resources, failed communications, increased system latency, and decreased user experience.

As described herein, the network may configure the UE with the time duration pattern, and may further indicate (e.g., via control signaling) which time intervals (e.g., slots or symbols) of the time duration pattern are designated as SBFD time intervals. Specifically, the network may indicate an SBFD time interval on a legacy downlink symbol, a legacy uplink symbol, or a legacy flexible symbol. The network may further indicate frequency resources (e.g., an uplink subband, a downlink subband, etc.) via which the UE is to perform the SBFD communication during the indicated time intervals. In some examples, the control signaling may include an indication of an SBFD mode for each of the time intervals (e.g., a control message, such as a radio resource control (RRC) message may indicate a 1 for an SBFD mode and a 0 for a another communication mode such as a half duplex mode). In some examples, multiple TRPs may communicate (e.g., via backhaul signaling or over the air signaling), to determine which TRP will schedule uplink signaling and which TRP will schedule downlink signaling in the SBFD time interval. In such examples, the configuration of the time duration patterns and/or the frequency resources may include an indication of a cell identifier corresponding to each cell (e.g., a cell ID for a set of uplink resources and a cell ID for a set of downlink resources, such that the UE can communicate via uplink and downlink signaling with the respective TRPs).

Aspects of the disclosure are initially described in the context of wireless communications systems. Aspects of the disclosure are further illustrated by and described with reference to wireless communications systems, wireless communications schemes, and process flows. Aspects of the disclosure are further illustrated by and described with reference to apparatus diagrams, system diagrams, and flowcharts that relate to communications by a subband full duplex capable UE in a half duplex cell mode.

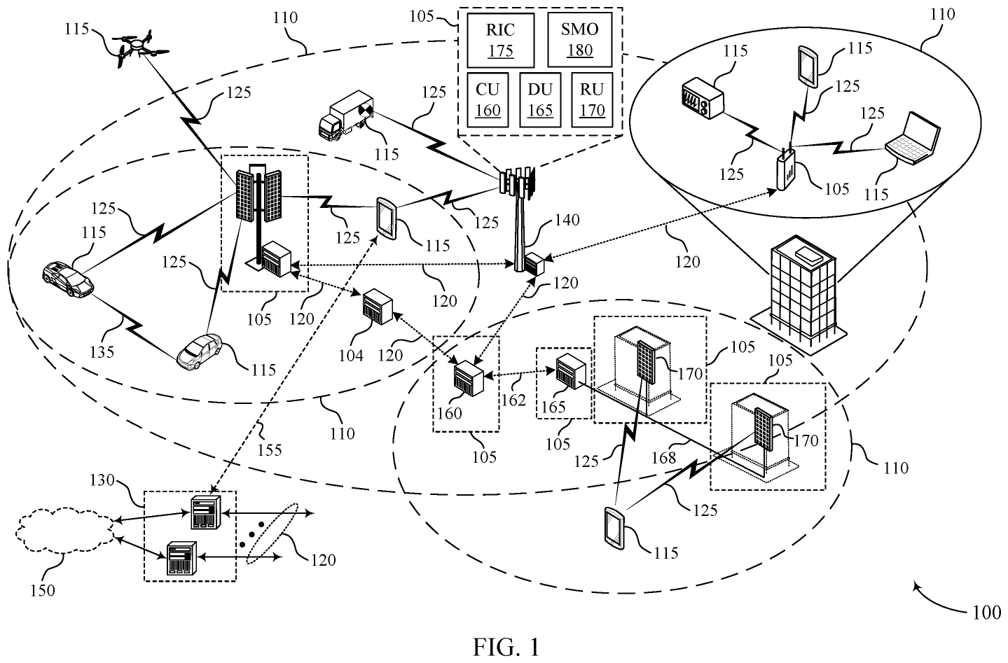

FIG. 1 shows an example of a wireless communications system 100 that supports communications by a subband full duplex capable UE in a half duplex cell mode in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support communications by a subband full duplex capable UE in a half duplex cell mode as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a subband, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring. equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking. Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHZ, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more subbands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some examples, the network may configure a UE 115 with the time duration pattern, and may further indicate (e.g., via control signaling) which time intervals (e.g., slots or symbols) of the time duration pattern are designated as SBFD time intervals. Specifically, the network may indicate an SBFD time interval on a legacy downlink symbol, a legacy uplink symbol, or a legacy flexible symbol. The network may further indicate frequency resources (e.g., an uplink subband, a downlink subband, etc.) via which the UE 115 is to perform the SBFD communication during the indicated time intervals. In some examples, the control signaling may include an indication of an SBFD mode for each of the time intervals (e.g., an control message, such as a radio resource control (RRC) message may indicate a 1 for an SBFD mode and a 0 for a another communication mode such as a half duplex mode). In some examples, multiple network entities 105 (e.g., TRPs) may communicate (e.g., via backhaul signaling or over the air signaling), to determining which TRP will schedule uplink signaling and which TRP will schedule downlink signaling in the SBFD time interval. In such examples, the configuration of the time duration patterns and/or the frequency resources may include an indication of a cell identifier corresponding to each cell (e.g., a cell ID for a set of uplink resources and a cell ID for a set of downlink resources, such that the UE can communicate via uplink and downlink signaling with the respective TRPs).

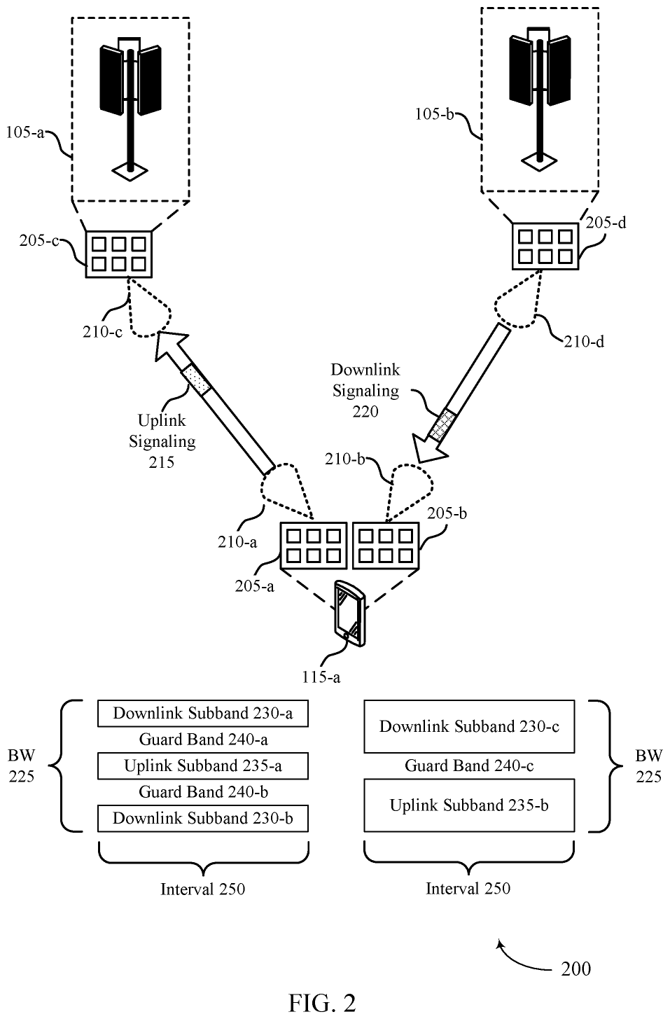

FIG. 2 shows an example of a wireless communications system 200 that supports communications by a subband full duplex capable UE in a half duplex cell mode in accordance with one or more aspects of the present disclosure. In some examples, the wireless communications system 200 may implement or be implemented by aspects of the wireless communications system 100. For example, the wireless communications system 200 may include one or more network entities 105 (e.g., a network entity 105-a and a network entity 105-b) and one or more UEs 115 (e.g., a UE 115-a), which may be examples of the corresponding devices described herein with reference to FIG. 1.

In some wireless communications systems, such as the wireless communications system 200, a network entity 105, such as the network entity 105-a, the network entity 105-b, or both, may be capable of operating according to an SBFD mode. In such cases, the network entity 105-a may configured one or more intervals 250 (e.g., symbols) of a CC with both uplink resources (e.g., one or more uplink subbands 235) and downlink resources (e.g., one or more downlink subbands 230). In such cases, the interval 250 may be referred to as an SBFD interval 250 (e.g., an SBFD slot or an SBFD symbol, among other examples). For example, the network entity 105-a may configure an interval 250 associated with a bandwidth (BW) 225 (e.g., of the CC) according to an SBFD pattern, such that the interval 250 supports a downlink subband 230-a, an uplink subband 235-a, and a downlink subband 230-b (D+U+D), where the downlink subband 230-a and the uplink subband 235-a are separated by a guard band 240-a (e.g., with a quantity of resource blocks (RBs)) and the uplink subband 235-a and the downlink subband 230-b are separated by a guard band 240-b. In another example. the network entity 105-a may configure the interval 250 associated with the BW 225 according to an SBFD pattern, such that the interval 250 supports a downlink subband 230-c and an uplink subband 235-b (D+U), where the downlink subband 230-c and the uplink subband 235-b are separated by a guard band 240-c (e.g., defined by a quantity frequency resources, such as a quantity of resource blocks). As such, the network entity 105-a may simultaneously communicate with a first UE 115, such as the UE 115-a, via the downlink subband(s) 230 and with a second UE 115, via the uplink subband(s) 235 in a same interval 250.

In some examples, the network entity 105-a may support SBFD in a TTD carrier (e.g., CC) or in intra-band CA. In such cases, as described with reference to the SBFD patterns, the network entity 105-a may support simultaneous transmission and reception of downlink and uplink communications, respectively, on a subband basis (e.g., or via any subsets of frequency resources, such as carriers, subbands, resource blocks, resource groups, among other examples). A network node (e.g., the network entity 105-a) that is capable of full duplex communication (e.g., SBFD network entities) ay be referred to as full duplex network entities. In some examples, the network entity 105-a, operating according to the SBFD mode, may increase an uplink duty cycle, which may increase uplink coverage and decrease latency (e.g., it is possible to transmit uplink signals in an uplink subband 235 in a downlink only or flexible interval 250 or receive downlink signals in downlink subband(s) 230 in legacy only uplink interval 250). Additionally, or alternatively, the network entity 105-a, operating according to the SBFD mode, may enhance system capacity, enhance resource utilization, enhance spectrum efficiency, and enable flexible and dynamic uplink and downlink resource adaption according to uplink and downlink traffic (e.g., in a robust manner), among other advantages.

In some examples, a UE 115, such as the UE 115-a, may be capable of operating according to an SBFD mode. In other words, the UE 115-a may simultaneously communicate with one or more network entities 105 (e.g., cells) via downlink subband(s) 230 and via uplink subband(s) 235 in a same interval 250. In some cases, the UE 115-a may simultaneously communicate with a single network entity 105, such as the network entity 105-a, via the downlink subband(s) 230 and via the uplink subband(s) 235 in the same interval 250. Similarly (e.g., due to the SBFD capabilities of the UE 115-a), the network entity 105-a may simultaneously communicate with a single UE 115, such as the UE 115-a, via downlink subband(s) 230 and via uplink subband(s) 235 in a same interval 250. Conversely, the network entity 105-a may simultaneously communicate with a first UE 115, such as the UE 115-a, via the downlink subband(s) 230 and with a second UE 115, such as the UE 115-a, via the uplink subband(s) 235 in the same interval 250.

As such, the UE 115-a (e.g., a UE 115 capable of operating according to an SBFD mode), which may be referred to as an SBFD capable UE, and the network entity 105-a (e.g., a network entity 105 capable of operating according to an SBFD mode), which may be referred to as an SBFD capable network entity. In some examples, the UE 115-a, the network entity 105-a, the network entity 105-b, or both, may support multiple communication modes. As described herein, a half-duplex wireless device (e.g., half-duplex mode wireless device), such as a half-duplex UE 115 or a half-duplex network entity 105, may refer to the wireless device operating according to a half-duplex mode, such as a UE half-duplex mode or a network entity half-duplex mode, respectively. Similarly, an SBFD wireless device (e.g., SBFD mode wireless device), such as an SBFD UE 115 or an SBFD network entity 105, may refer to the wireless device operating according to an SBFD mode, such as a UE SBFD mode or a network entity SBFD mode, respectively.

The UE 115-a, the network entity 105-a, the network entity 105-b, or any combination thereof, may support one or more communication modes. For example, in a first communication mode (e.g., half-duplex mode UE 115+half-duplex mode network entity 105), the network entity 105-b performs half-duplex communications with a single UE 115 in a single time-based resource (e.g., an interval 250, such as a frame, sub-frame, slot, or symbol). In some examples, the UE 115-a may support an SBFD mode UE 115+half duplex mode network entity or entities 105). In such examples, the UE 115-a (e.g., an SBFD capable UE) may communicate with one SBFD capable network entity 105-a, or may simultaneously perform uplink and downlink communications during an interval 22—with two network entities (e.g., the network entity 105-a and the network entity 105-b). The network entity 105-a and the network entity 105-b may support a half-duplex mode and may not support an SBFD mode (e.g., a half-duplex TRP that is not capable of SBFD mode communications, or is operating in a half-duplex TRP). In some examples, SBFD communications may partially or fully overlap with half duplex communications. For instance, an SBFD capable UE 115-a may communicate with one or more lower capability cells or TRPs. Such communications between an SBFD capable UE 115-a and two half duplex cells or TRPs (e.g., the network entity 105-a and the network entity 105-b operating in a half duplex mode) may be referred to as an HD cell/TRP+SBFD UE communicate mode, or an HD cell and SBFD UE mode. For instance, the UE 115-a may be associated with one or more antenna panel 205 (e.g., the antenna panel 205-a and the antenna panel 205-b). The UE 115-a may transmit uplink signaling 215 to the network entity 105-a via transmit beam 210-a, and the network entity 105-a may receive the uplink signaling 215 via a receive beam 210-c and an antenna panel 205-c. The UE 115-a may also receive downlink signaling 220 (e.g., from the network entity 105-a if the network entity 105-a is operating in an SBFD mode, or from the network entity 105-b if the network entity 105-a and the network entity 105-b operate in a HD mode). For example, the network entity 105-b may transmit the downlink signaling 220 via the antenna panel 205-d and the transmit beam 210-d. The UE 115-b may receive the downlink signaling 220 via the receive bean 210-b and the antenna panel 205-d. The UE 115-b may simultaneously transmit the uplink signaling 215 via an uplink subband 235, and receive the downlink signaling 220 via one or more downlink subbands 230, during an interval 250.

In such examples, the UE 115-a may operate in an SBFD mode with one or more half duplex TRPs. However, some SBFD configuration or control signaling may be associated with an SBFD mode at the network entity. Without such signaling for the SBFD mode at the UE 115-a, SBFD communications may not be possible, or may fail. For instance, one or more TRPs operating in half duplex mode may configure the UE with time intervals 250 (e.g., slots or symbols) allocated for uplink or downlink signaling (e.g., but not configured for simultaneous uplink and downlink signaling). In such examples, despite supporting the capability to perform SBFD communications, the UE 115-a may only communicate uplink or downlink signaling during a given interval 250, resulting in inefficient use of available system resources, increased system latency, increased system delays, and decreased user experience.

The UE 115-a may determine the resources via which to perform the SBFD communications (e.g., the interval 250, the uplink subband 235, the downlink subband 230, or any combination thereof) according to techniques described herein. For example, the UE 115-a may receive (e.g., from the network via one or more of the network entity 105-a, the network entity 105-b) control signaling indicating a time duration pattern. The time duration pattern may be referred to as a TDD pattern, a frame structure, a timing pattern, or a communication pattern. The time duration pattern may define uplink (U), downlink (D), and special(S) or flexible time intervals. Time intervals may refer to any designation of time, including slots, symbols, mini-slots, frames, sub-frames, timers, or configured amounts of time. Although discussed with reference to slots and symbols, time intervals described herein may refer to any example of a specific amount of time. For example, the frame structure may define a pattern of U. D. and S slots or symbols, such as DDDSU (e.g., three downlink slots or symbols, followed by a special slot or symbol, followed by an uplink slot or symbol). The frame structure may include a repeating pattern (e.g., DDDSUDDDSU). In some examples, the time duration pattern may be configured via control signaling (e.g., RRC signaling, such as a TDD-UL-DL-ConfigCommon).

The UE 115-a, which may operate in a UE SBFD mode+HD TRPs/cells, may be configured with one or more time intervals of the time duration pattern via which to perform SBFD communications. For example, the UE 115-a may also receive control signaling indicating that one or more of the time intervals (e.g., symbols or slots of the time duration pattern) are allocated for SBFD mode communications. In some examples, the SBFD capable UE 115-a may be configured (e.g. semi-statically configured) with uplink subbands as UE SBFD symbols or slots on previously configured downlink slots or symbols. For example, the UE 115-a may receive control signaling indicating that one or more downlink time intervals (e.g., one or more D slots or D symbols of the time duration pattern). The UE 115-a may then perform SBFD communications during the indicated time interval (e.g., the indicated D slot or D symbol), according to one or more rules.

In such examples, uplink transmissions may be supported via one or more uplink resources (e.g., an uplink subband 235) during the indicated time interval (e.g., the indicated D slot or D symbol). Uplink transmissions outside of the uplink resources (e.g., outside of uplink subbands 235) may not be permitted during the indicated D slot or D symbol. The frequency location of downlink subbands 230, or uplink subbands 235, or both, may be determined by the UE 115-a. For example, the UE 115-a may receive explicit indications of the downlink subband 230, the uplink subband 235, or both. Such allocations of downlink subbands 230 or uplink subbands 235 may be indicated via the first control signaling (e.g., indicating the time duration pattern), the second control signaling (e.g., indicating the time intervals allocated for SBFD mode communications), or third control signaling (e.g., separate control signaling indicating resources for uplink subbands 235, downlink subbands 230, or both). In some examples, the UE 115-a may implicitly derive frequency location of the downlink subbands 230. For example, the UE 115-a may be configured with guard bands 240 (e.g., and uplink subbands 235), and may implicitly derive the downlink subbands 230 based on the guard bands 240. Downlink reception may be supported via the downlink subbands 230 (e.g., according to the one or more rules). The UE 115-a may perform uplink transmissions via the uplink subband 235 during the indicated interval 250 within an active uplink BWP and may perform downlink reception via the downlink subband 230 within an active downlink BWP during the indicated interval 250.

In some examples, the SBFD capable UE 115-a may be configured (e.g. semi-statically configured) with uplink subbands as UE SBFD symbols or slots on previously configured downlink symbols or slots. For example, the UE 115-a may receive control signaling indicating that one or more downlink time intervals (e.g., one or more D slots or D symbols of the time duration pattern) are designated for full duplex communications. The UE 115-a may then perform full duplex communications during the indicated time interval (e.g., the indicated D slot or D symbol), according to the one or more rules. In some examples, uplink transmissions may be supported during the designated D time interval (e.g., full duplex communications may be performed) within an active BWP, and downlink receptions may be supported during the designated D time interval (e.g., the full duplex communications may be performed) within the active BWP.

The SBFD capable UE 115-a may be configured (e.g. semi-statically configured) with uplink subbands as UE SBFD symbols or slots on previously configured flexible time intervals (e.g., symbols or slots). For example, the UE 115-a may receive control signaling indicating that one or more downlink time intervals (e.g., one or more D slots or D symbols of the time duration pattern) are designated for full duplex communications. The UE 115-a may then perform full duplex communications during the indicated time interval (e.g., the indicated D slot or D symbol), according to one or more rules.

In some examples, the SBFD capable UE 115-a may be configured (e.g. semi-statically configured) with uplink subbands as UE SBFD symbols or slots on previously configured flexible(S) symbols. For example, the UE 115-a may receive control signaling indicating that one or more downlink time intervals (e.g., one or more S slots or S symbols of the time duration pattern) are designated for full duplex communications. The UE 115-a may then perform full duplex communications during the indicated time interval (e.g., the indicated D slot or D symbol), according to the one or more rules.

In such examples, uplink transmissions may be supported via one or more uplink resources (e.g., an uplink subband 235) during the indicated time duration (e.g., the indicated S slot or S symbol), In some examples, uplink transmissions outside of uplink subbands 235 may not be supported during the indicated time duration (e.g., the indicated S slot or S symbol). Frequency locations of downlink subbands 230 may be known to the UE 115-a (e.g., an SBFD capable UE 115). Downlink reception within downlink subbands 230 may be supported during the designated S time interval. In some examples, frequency resources (e.g., one or more RBs) outside o the uplink subband 235 may be used as uplink or downlink resources (e.g., excluding guard bands 240, if utilized or configured at the UE 115-a) during the designated S time interval for full duplex communications. For example, from the perspective of a network entity 105, resources outside of the uplink subband 235 of the designated S time interval may be utilized for uplink or downlink signaling (e.g., by the UE 115 or by other UEs), and the transmission direction for such RBs may be the same. Frequency locations of downlink subbands 230 may be known to the UE 115-a (e.g., an SBFD capable UE 115), and downlink receptions within the downlink subbands 230 may be supported. In some examples, uplink transmissions may be supported during the designated S time interval (e.g., full duplex communications may be performed) within an active BWP, and downlink receptions may be supported during the designated S time interval (e.g., the full duplex communications may be performed) within the active BWP.

In some examples, the SBFD capable UE 115-a may be configured (e.g., semi-statically configured) with uplink subbands as UE SBFD symbols or slots on previously configured uplink symbols. For example, the UE 115-a may receive control signaling indicating that one or more downlink time intervals (e.g., one or more U slots or U symbols of the time duration pattern) are designated for full duplex communications. The UE 115-a may then perform full duplex communications during the indicated time interval (e.g., the indicated U slot or U symbol), according to the one or more rules.

In such examples, downlink receptions may be supported via one or more downlink resources (e.g., downlink subbands 230) during the designated U time interval. Downlink reception outside of the downlink subbands 230 may not be supported during the designated U time interval. Frequency locations of uplink subbands 235 may be known to the UE 115 (e.g., may be configured for an SBFD capable UE 115). The frequency location of uplink subbands 235 maybe explicitly indicated to the UE 115-a (e.g., via control signaling from the network), or may be implicitly derived (e.g., the SBFD capable UE 115-a is configured with guard bands 240, then the uplink subbands 235 may be implicitly derived based on the downlink subband 230, the guard band 240, or both). Uplink transmissions within the uplink subband 235 may be supported during the indicated U time interval. In some examples, uplink transmissions may be supported during the designated U time interval (e.g., full duplex communications may be performed) within an active BWP, and downlink receptions may be supported during the designated U time interval (e.g., the full duplex communications may be performed) within the active BWP.

In some examples, if the full duplex UE is a fully overlapping full duplex UE (e.g., the full duplex communications are fully overlapping in time), then the time location of the full duplex operation may be configured at the UE 115-a (e.g., the full duplex operation may be performed via the uplink subband 235 and downlink subband 230 during the designated time interval). However, if the UE 115-a supports SBFD communications, or partial overlapping full duplex operation, then the full duplex communications may rely on an indication of downlink subbands 230 and uplink subbands 235. In such examples (e.g., for partial overlapping full duplex communications or for SBFD communications), the network may provide control signaling indicating both the time resources (e.g., may indicate a previously configured D. S, or U time interval for full duplex communication) and the frequency resources (e.g., one or more downlink subbands 230, and one or more uplink subbands 235) for the full duplex communications. IN some examples, if the UE 115-a is configured with two cells, then the two cells may configure different time duration patterns (e.g., different slot formats or symbol formats) as dynamic TDD configurations for full duplex operations. In such examples, the two time duration patterns for the two cells may provide different direction of signaling corresponding to the different cells. For instance, according to the configured time duration patterns, the full duplex UE 115-a may perform downlink signaling during an indicated time interval via a downlink time interval (e.g., D slot or D symbol) on a first cell, and may perform uplink signaling (e.g., during the same indicated time interval) via an uplink time interval (e.g., U slot or U symbol) on the second cell.

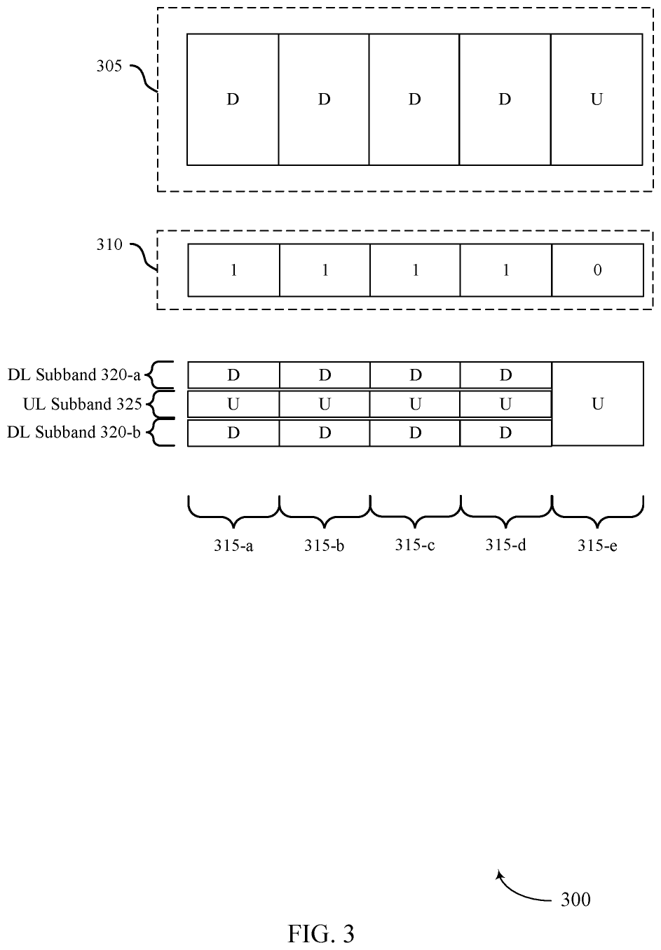

FIG. 3 shows an example of a wireless communications scheme 300 that supports communications by a subband full duplex capable UE in a half duplex cell mode in accordance with one or more aspects of the present disclosure. The wireless communications scheme 300 may implement aspects of, or be implemented by aspects of, the wireless communications system 100 and the wireless communications system 200. For example, a UE (e.g., such as a UE 115-a) and one or more network entities (e.g., the network entity 105-a, the network entity 105-b, or both), which may be examples of corresponding devices described with reference to FIGS. 1-2, may communicate according to the wireless communications scheme 300.

The UE may be a full duplex capable UE (e.g., such as an SBFD capable UE), and may operate in a full duplex mode (e.g., an SBFD mode+HD TRPs/cells mode) in one or more time intervals 315 (e.g., in UE SBFD symbols or slots). The network may indicate, to the UE, which time intervals 315 in which the UE is to perform full duplex operations. For instance, the UE may receive first control signaling 305, which may indicate a time duration pattern (e.g., a pattern of slots of symbols, such as DDDU, indicating four downlink time intervals 315 and one uplink time interval 315). The UE may receive second control signaling 310 indicating which of the time intervals 315 (e.g., allocated as U or D or S time intervals by the first control signaling) are designated for full duplex operations.

In some examples, to support the full duplex operations in some of the time intervals 315 of the time duration pattern, the UE may interpret a control message, such as SBFD configuration signaling (e.g., the control signaling 310) as applying to the SBFD UE+HD cell operation. For example, a network entity may transmit time resources and downlink/uplink subband configuration signaling (e.g., to any UE). The UE may interpret such information as indicating time and/or frequency resources for full duplex operations in a given (e.g., designated) time interval 315. For instance, the second control signaling 310 may include the SBFD time and downlink/uplink subband confirmation information, and may include an indication as to whether the UE is to apply an SBFD mode (e.g., a 1 of a one-bit indicator) or whether the UE is to apply another (e.g., legacy) communication mode. The UE may then transmit in indicated uplink SBFD symbols or slots via an uplink subband 325, and the SBFD UE may receive indicated UE SBFD symbols or slots via downlink subbands 320.

For example, the first control signaling 305 may indicate the time duration pattern of time intervals 315 (e.g., DDDDU). The second control signaling 310 (e.g., which may include an indication of one or more uplink subbands 325, one or more downlink subbands 320, one or more guard bands, etc.) may include an indication as to whether the UE is to apply the full duplex mode or another communication mode for each time interval 315. For instance, a full duplex UE time indication (e.g., a bitmap in the second signaling 310) may include a bit for each time interval 315 (e.g., 11110). In such examples, the UE may apply the full duplex communication mode to time interval 315-a, time interval 315-b, time interval 315-c, and time interval 315-d (e.g., may transmit uplink signaling via an uplink subband 325, and simultaneously receive downlink signaling via the downlink subband 320-a and the downlink subband 320-b). The indicator in the second control signaling 310 may indicate another communication mode for the time interval 315-e (e.g., or the absence of the full duplex mode), in which case the UE may perform wireless signaling during the time interval 315-e according to the time duration pattern (e.g., the UE may transmit uplink signaling via the time interval 315-e).

In some examples, the time duration pattern (e.g., indicated via the first control signaling 305) may correspond to a first cell (e.g., cell1). In some examples, the UE may receive downlink signaling from a first TRP via the downlink subbands 320 during the full duplex time intervals 315, and may transmit uplink signaling to a second TRP via the uplink subband 325 during the full duplex time intervals 315.

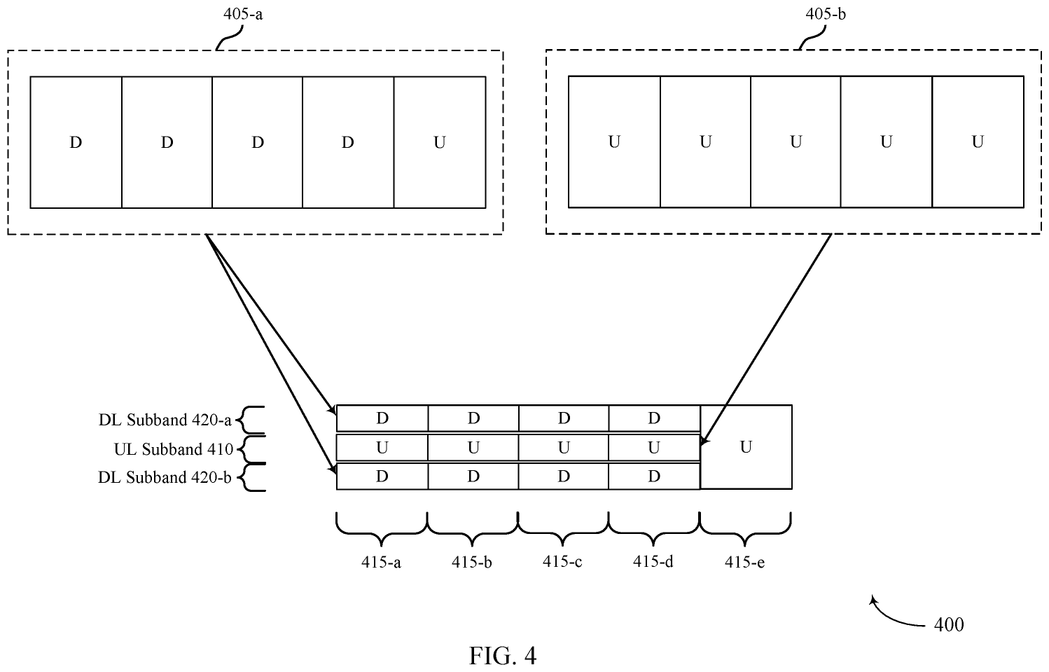

FIG. 4 shows an example of a wireless communications scheme 400 that supports communications by a subband full duplex capable UE in a half duplex cell mode in accordance with one or more aspects of the present disclosure. The wireless communications scheme 400 may implement aspects of, or be implemented by aspects of, the wireless communications system 100, the wireless communications system 200, and the wireless communications scheme 300. For example, a UE (e.g., such as a UE 115-a) and one or more network entities (e.g., the network entity 105-a, the network entity 105-b, or both), which may be examples of corresponding devices described with reference to FIGS. 1-3, may communicate according to the wireless communications scheme 400.

The UE may be a full duplex capable UE (e.g., such as an SBFD capable UE), and may operate in a full duplex mode (e.g., an SBFD mode+HD TRPs/cells mode) in one or more time intervals 415 (e.g., in UE SBFD symbols or slots). The network may indicate, to the UE, which time intervals 415 in which the UE is to perform full duplex operations. For instance, the UE may receive first control signaling, which may indicate a time duration pattern 405 (e.g., a pattern of slots of symbols, such as DDDU, indicating four downlink time intervals 415 and one uplink time interval 415). The UE may receive second control signaling indicating which of the time intervals 415 (e.g., allocated as U or D or S time intervals by the first control signaling) are designated for full duplex operations.

In some examples, the UE may connect to two cells (e.g., two cells, two DUs, among other examples). In such examples, the network entities may perform information exchange (e.g., gNB coordination) for configuration of SBFD UE time intervals 415 (e.g., on a per cell basis, per DU basis, per CU basis, among other examples). The TRPs may coordinate to determine (and configure at the UE) directionality associated with each cell, and may also coordinate regarding frequency resources (e.g., downlink subbands 420 and uplink subbands 410) associated with each cell. Such information may be exchanged between cell via backhaul signaling (e.g., F1AP or Xn signaling) or over the air signaling. Thus, the coordination signaling exchanged between cells or TRPs may include an indication of time intervals 415 for full duplex operation on a per cell, per component carrier, per DU, or per CU basis, directionality (e.g., D or U directionality) per time interval 415 associated with each cell or each component carrier (e.g., or each DU or each CU), frequency resources (e.g., the downlink subbands 420 and uplink subbands 410) associated with each cell or with each component carrier.

For example, a time duration pattern 405-a may correspond to (e.g., be configured for or by) a first TRP (e.g., the network entity 105-a, as illustrated with reference to FIG. 2), and a second time duration pattern 405-b may correspond to (e.g., be configured for or by) a second TRP (e.g., the network entity 105-b, as illustrated with reference to FIG. 2). In some examples, the time duration pattern 405-a may be referred to as a first portion of a time duration pattern, and the time duration pattern 405-b may be referred to as a second portion of a time duration pattern. The first TRP (e.g., the network entity 105-a) may transmit (e.g., via backhaul signaling or over the air signaling) an indication to the second TRP (e.g., the network entity 105-a) an indication of frequency resources, directionality of signaling, time intervals 415, allocated for communicating with the UE. For instance, the first TRP may indicate the downlink subband 420-a, the downlink subband 420-b, the time interval 415-a, the time interval 415-b, the time interval 415-c, and the time interval 415-d, a directionality (e.g., downlink), or any combination thereof, to the second TRP. Similarly, the second TRP may indicate (e.g., autonomously, or in response to the indication received from the first TRP), frequency resources, time resources, directionality, or any combination thereof, to the first TRP.

The network may configure the UE (e.g., via one or both of the two cells or the two TRPs) with the time duration pattern 405-a, the time duration pattern 405-b, and second control signaling indicating which time intervals 415 are designated for full duplex signaling. In some examples, the second control signaling (e.g., or the first control signaling) may also indicate frequency resources for a full duplex operation (e.g., the uplink subband 410 and the downlink subbands 420), time resources for the full duplex operation (e.g., the designated time intervals 415, including the time interval 415-a, the time interval 415-b, the time interval 415-c, and the time interval 415-d), directionality associated with the two TRPs, or any combination thereof. In some examples, such indications may be configured at the UE in accordance with the coordination between the TRPs. In such examples, the UE may be configured to receive downlink signaling from the first TRP via the downlink subband 420-a and the downlink subband 420-b during the time interval 415-a, the time interval 415-b, the time interval 415-c, and the time interval 415-d. The UE may also transmit uplink signaling to the second TRP via the uplink subband 410 during the time interval 415-a, the time interval 415-b, the time interval 415-c, and the time interval 415-d. The UE may perform uplink signaling (e.g., in a non-full duplex communication mode) via the time interval 415-e. In some examples, the control signaling (e.g., the second control signaling) may include an indication of a cell ID corresponding to the first TRP or a first cell (e.g., for the downlink signaling), an indication of the second cell ID corresponding to the second TRP or second cell (e.g., for the uplink signaling), or both.

As described herein, the first TRP and the second TRP may coordinate such that each may operate in a half duplex mode, while the UE operates in a full duplex mode. For example, the first TRP (e.g., a first cell) may communicate with the UE according to the time duration pattern 405-a (e.g., may transmit downlink signaling via the downlink subbands 420) and the second TRP (e.g., the second cell) may communicate with the UE according to the time duration pattern 405-b (e.g., may receive uplink signaling via the uplink subband 410). The two TRPs may coordinate with each other to ensure that each time interval 415 is configured such that the UE may perform full duplex operations where a directionality of the uplink and the downlink signaling is appropriately assigned to uplink and downlink subbands.

In some examples, a UE, a network entity, or both, may support intra carrier aggregation (CA) full duplex operations (e.g., intra-CA based gNB SBFD operations, or intra-CA based UE SBFD operations). In such examples, a first component carrier (CC) (e.g., CC1) may be utilized for downlink signaling with the UE, and a second CC (e.g., CC2) may be utilized for uplink signaling with another UE. Signaling for network-entity based inter-CA full duplex operations (e.g., where the network entity simultaneously performs uplink and downlink signaling with two UEs) may be utilized (e.g., or similar signaling may be utilized) to indicate (e.g., to a full duplex capable UE) that CC1 is allocated for downlink signaling by cell 1, and CC2 is allocated for uplink signaling at cell 2 (e.g., if the two CCs are utilized by the same DU). Signaling indicating which CC is associated with which cell, TRP, directionality, or any combination thereof, may be exchanged between TRPs (e.g., during inter-TRP coordination, as described herein), may be indicated to the UE (e.g., via the second control signaling, or additional control signaling), or a combination thereof.

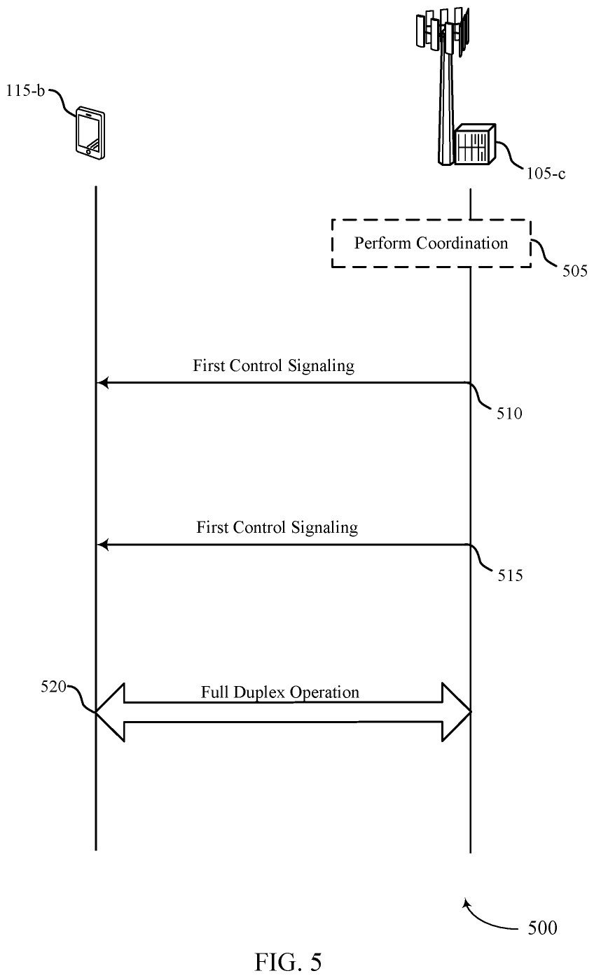

FIG. 5 shows an example of a process flow 500 that supports communications by a subband full duplex capable UE in a half duplex cell mode in accordance with one or more aspects of the present disclosure. The process flow 500 may implement, or be implemented by, aspects of the wireless communications system 100, the wireless communications system 200, the wireless communications scheme 300, the wireless communications scheme 400, or any combination thereof. For example, the process flow 500 may include a UE 115-b, and one or more network entities 105-c, which may be examples of corresponding devices described with reference to FIGS. 1-4. In some examples, the UE 115-b may perform techniques described herein by communicating with a single network entity 105-b. In some examples, the UE 115-b may perform techniques described herein by communicating with multiple network entities 105-b (e.g., with a first TRP, and a second TRP, as described with reference to FIG. 4). The UE 115-b may support a full duplex mode (e.g., an SBFD communication mode, a partially overlapping full duplex communication mode, or a fully overlapping duplex communication mode, among other examples).

At 510, the UE 115-b may receive first control signaling, which may include an indication of a time duration pattern for wireless communication with the network via one or more time intervals, the time intervals including a first set of downlink time intervals (e.g., D slots or symbols), a second set of uplink time intervals (e.g., U slots or symbols), a third set of flexible time intervals (e.g., S slots or symbols), or any combination thereof.

At 515, the UE 115-b may receive second control signaling, which may include an indication designating one or more time intervals of the time duration pattern for wireless communications by the UE 115-b according to a full duplex mode supported by the UE 115-b. For example, the second control signaling may indicate during which time intervals (e.g., D slots or symbols, U slots or symbols, or S slots or symbols, or any combination thereof) the UE is permitted to perform full duplex operations (e.g., simultaneously transmitting and receiving via the designated D, U, or S slot or symbol).

In some examples, the UE 115-b may receive a single control message (e.g., an RRC message, a MAC-CE message, or a DCI message), which may include one or more fields for the first control signaling (e.g., indicating the time duration pattern) and one or more fields for the second control signaling (e.g., indicating which of the time intervals of the time duration pattern are allocated for full duplex operations). In some examples, the UE 115-b may receive a first control message including the first control signaling (e.g., a first RRC message, a first MAC-CE message, or a first DCI message), and may also receive a second control message including the second control signaling (e.g., a second RRC message, a second MAC-CE message, or a second DCI message).

At 520, the UE 115-b may perform wireless communications according to the full duplex mode during the indicated time intervals. For example, the UE 115-b may simultaneously transmit uplink signaling and receive downlink signaling via the designated time intervals of the time duration pattern according to the indication and according to the full duplex mode.

In some examples, the network may configure the UE with frequency resources via which to perform the full duplex communications. For example, the UE 115-b may receive (e.g., via the second control signaling at 515), an indication of at least one uplink subband for the uplink signaling and at least one downlink subband for the downlink signaling corresponding to the one or more time intervals according to the full duplex mode. In such examples, at 520, the UE may transmit the uplink signaling during the one or more time intervals and via the one uplink subband, and may receive the downlink signaling during the one or more time intervals and via the at least one downlink subband.

In some examples, full duplex communications may be supported (e.g., as designated via the second control signaling) via downlink time intervals (e.g., D slots or symbols). For example, the second control signaling may designate one or more downlink time intervals of the first set of downlink time intervals for the wireless communications by the UE according to the full duplex mode. In some examples, the full communications may be supported (e.g., as designated via the second control signaling) via flexible time intervals (e.g., S slots or symbols). For example, the second control signaling may designate one or more flexible time intervals of the first set of downlink time intervals for the wireless communications by the UE according to the full duplex mode. In some examples, the full communications may be supported (e.g., as designated via the second control signaling) via uplink time intervals (e.g., U slots or symbols). For example, the second control signaling may designate one or more uplink time intervals of the first set of downlink time intervals for the wireless communications by the UE according to the full duplex mode.

In some examples, the UE 115-b may perform full duplex communications with multiple cells, or multiple TRPs. In such examples, the first control signaling may include a first portion of a time duration pattern (e.g., the time duration pattern 405-a, as illustrated with reference to FIG. 4), and a second portion of the time duration pattern (e.g., the time duration pattern 405-b, as illustrated with reference to FIG. 4). The first portion of the time duration pattern may correspond to a first cell or a first TRP, and the second portion of the time duration pattern may correspond to a second cell or second TRP. The network (e.g., via one or both TRP or cell) may configure the UE to transmit uplink signaling (e.g., via an uplink subband) to the first cell or TRP, and to receive downlink signaling (e.g., via a downlink subband) from the second cell or TRP, according to the first portion and the second portion of the time duration pattern. In some examples, the first cell or TRP may be associated with a first CC (e.g., CC1 may be allocated for uplink signaling by the UE 115-b in full duplex mode) and the second cell or TRP may be associated with a second CC (e.g., CC2 may be allocated for receiving downlink signaling by the UE 115-b in the full duplex mode).

In some examples, at 505, the network entity 105-b may perform coordination with another network entity 105 (e.g., a first TRP and a second TRP). For example, the network entity 105-b may transmit (e.g., via a backhaul link or over the air signaling) a message to the second network entity 105 indicating the time duration pattern (e.g., or a first portion of the time duration pattern), one or more uplink subbands, one or more downlink subbands, a directionality of scheduled signaling, or any combination thereof. The network entity 105-b may receive signaling (e.g., via the backhaul link or over the air signaling) indicating a second time duration pattern (e.g., or the second portion of the time duration pattern), one or more uplink subbands, one or more downlink subbands, a directionality for scheduled signaling, or any combination thereof. In some examples, based on the coordination, the network entity 105-b, the second network entity 105 (e.g., the second TRP), or both, may transmit the first control signaling at 510 and the second control signaling at 515, and may configure the full duplex operation at the UE 115-b based thereon (e.g., as illustrated with reference to FIG. 4).

In some examples, the UE 115-b may receive (e.g., via the second control signaling at 515), an indication that the full duplex mode applies to each of the one or more time intervals in the UE supported full duplex mode. For example, as described in greater detail with reference to FIG. 3, the network entity 105-b may indicate (e.g., via an indicator, such as a bitmap) which time intervals are designated for full duplex mode, and which time intervals are not (e.g., are designated for another communication mode, such as half duplex uplink signaling or half duplex downlink signaling during a time interval of the time duration pattern).

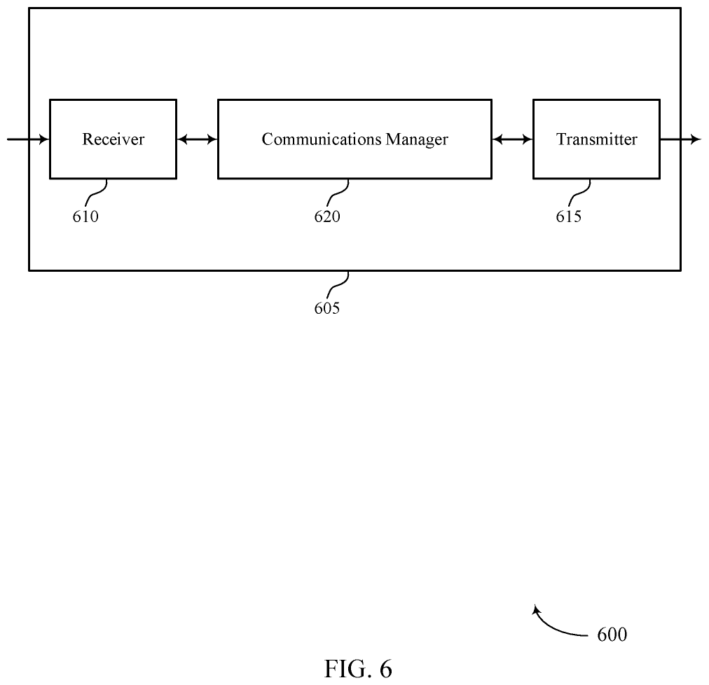

FIG. 6 shows a block diagram 600 of a device 605 that supports communications by a subband full duplex capable UE in a half duplex cell mode in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to communications by a subband full duplex capable UE in a half duplex cell mode). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to communications by a subband full duplex capable UE in a half duplex cell mode). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of communications by a subband full duplex capable UE in a half duplex cell mode as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor. If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving first control signaling including an indication of a time duration pattern for wireless communication with a network via a set of multiple time intervals, the set of multiple time intervals including a first set of downlink time intervals, a second set of uplink time intervals, a third set of flexible time intervals, or any combination thereof. The communications manager 620 is capable of, configured to, or operable to support a means for receiving second control signaling designating one or more time intervals of the set of multiple time intervals for wireless communications by the UE according to a full duplex mode supported by the UE. The communications manager 620 is capable of, configured to, or operable to support a means for simultaneously transmitting uplink signaling and receiving downlink signaling via the one or more time intervals of the set of multiple time intervals according to the indication and according to the full duplex mode.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for communications by a subband full duplex capable UE resulting in more efficient use of available system resources, more reliable communications, decreased system latency, and improved user experience.

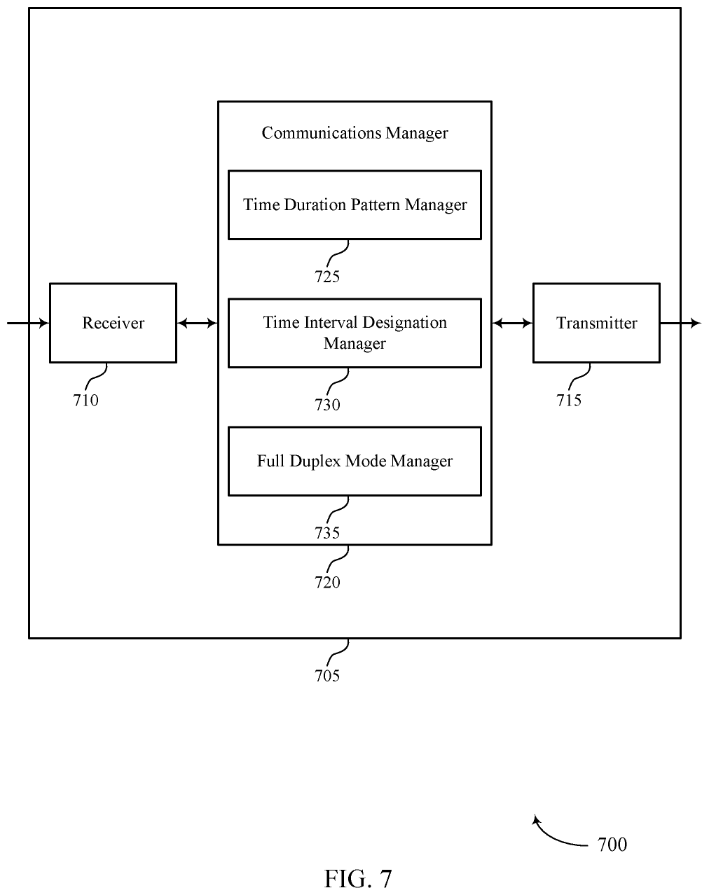

FIG. 7 shows a block diagram 700 of a device 705 that supports communications by a subband full duplex capable UE in a half duplex cell mode in accordance with one or more aspects of the present disclosure. The device 705 may be an example of aspects of a device 605 or a UE 115 as described herein. The device 705 may include a receiver 710, a transmitter 715, and a communications manager 720. The device 705, or one of more components of the device 705 (e.g., the receiver 710, the transmitter 715, and the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to communications by a subband full duplex capable UE in a half duplex cell mode). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to communications by a subband full duplex capable UE in a half duplex cell mode). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of communications by a subband full duplex capable UE in a half duplex cell mode as described herein. For example, the communications manager 720 may include a time duration pattern manager 725, a time interval designation manager 730, a full duplex mode manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The time duration pattern manager 725 is capable of, configured to, or operable to support a means for receiving first control signaling including an indication of a time duration pattern for wireless communication with a network via a set of multiple time intervals, the set of multiple time intervals including a first set of downlink time intervals, a second set of uplink time intervals, a third set of flexible time intervals, or any combination thereof. The time interval designation manager 730 is capable of, configured to, or operable to support a means for receiving second control signaling designating one or more time intervals of the set of multiple time intervals for wireless communications by the UE according to a full duplex mode supported by the UE. The full duplex mode manager 735 is capable of, configured to, or operable to support a means for simultaneously transmitting uplink signaling and receiving downlink signaling via the one or more time intervals of the set of multiple time intervals according to the indication and according to the full duplex mode.

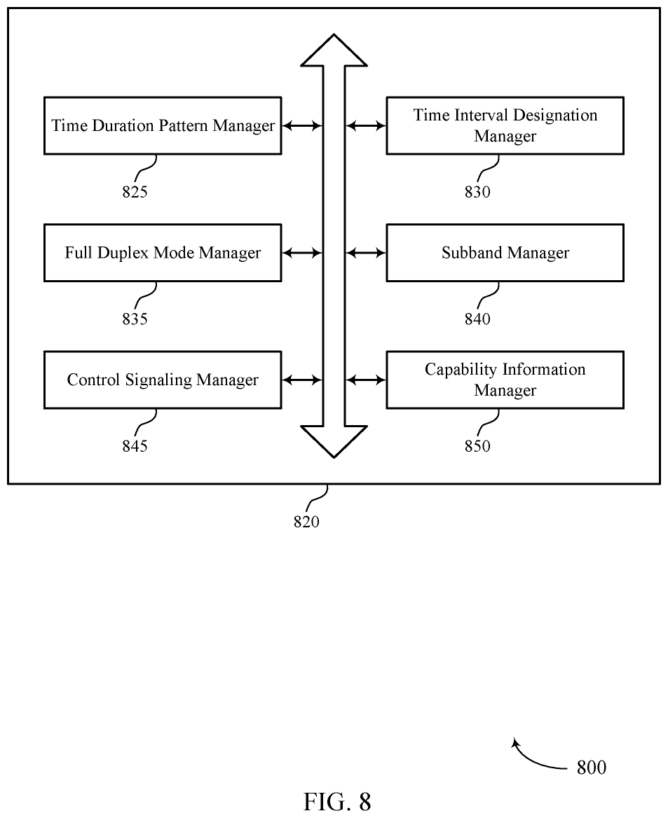

FIG. 8 shows a block diagram 800 of a communications manager 820 that supports communications by a subband full duplex capable UE in a half duplex cell mode in accordance with one or more aspects of the present disclosure. The communications manager 820 may be an example of aspects of a communications manager 620, a communications manager 720, or both, as described herein. The communications manager 820, or various components thereof, may be an example of means for performing various aspects of communications by a subband full duplex capable UE in a half duplex cell mode as described herein. For example, the communications manager 820 may include a time duration pattern manager 825, a time interval designation manager 830, a full duplex mode manager 835, a subband manager 840, a control signaling manager 845, a capability information manager 850, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The time duration pattern manager 825 is capable of, configured to, or operable to support a means for receiving first control signaling including an indication of a time duration pattern for wireless communication with a network via a set of multiple time intervals, the set of multiple time intervals including a first set of downlink time intervals, a second set of uplink time intervals, a third set of flexible time intervals, or any combination thereof. The time interval designation manager 830 is capable of, configured to, or operable to support a means for receiving second control signaling designating one or more time intervals of the set of multiple time intervals for wireless communications by the UE according to a full duplex mode supported by the UE. The full duplex mode manager 835 is capable of, configured to, or operable to support a means for simultaneously transmitting uplink signaling and receiving downlink signaling via the one or more time intervals of the set of multiple time intervals according to the indication and according to the full duplex mode.

In some examples, the subband manager 840 is capable of, configured to, or operable to support a means for receiving, via the second control signaling, an indication of at least one uplink subband for the uplink signaling and at least one downlink subband for the downlink signaling corresponding to the one or more time intervals according to the full duplex mode, where transmitting the uplink signaling via the one or more time intervals is based on the indication of the at least one uplink subband, and receiving the downlink signaling via the one or more time intervals is based on the indication of the at least one downlink subband.

In some examples, the second control signaling designates one or more downlink time intervals of the first set of downlink time intervals for the wireless communications by the UE according to the full duplex mode, and where the uplink signaling is transmitted via the at least one uplink subband during the designated one or more downlink time intervals and the downlink signaling is received via the at least one downlink subband during the designated one or more uplink time intervals.

In some examples, the second control signaling designates one or more uplink time intervals of the second set of uplink time intervals for the wireless communications by the UE according to the full duplex mode, and where the uplink signaling is transmitted via the at least one uplink subband during the designated one or more uplink time intervals and the downlink signaling is received via the at least one downlink subband during the designated one or more downlink time intervals.

In some examples, the second control signaling designates one or more flexible time intervals of the third set of flexible time intervals for the wireless communications by the UE according to the full duplex mode, and where the uplink signaling is transmitted via the at least one uplink subband during the designated one or more flexible time intervals and the downlink signaling is received via the at least one downlink subband during the designated one or more flexible time intervals.

In some examples, the full duplex mode supported by the UE includes a subband full duplex mode, or a partially overlapping full duplex mode, and where receiving the indication of the at least one uplink subband and the at least one downlink subband is based on the subband full duplex mode or the partially overlapping full duplex mode supported by the UE.

In some examples, the time duration pattern manager 825 is capable of, configured to, or operable to support a means for receiving, via the first control signaling, a first portion of the time duration pattern corresponding to a first cell or a first transmission reception point and a second portion of the time duration pattern corresponding to a second cell or a second transmission reception point. In some examples, the time duration pattern manager 825 is capable of, configured to, or operable to support a means for receiving, via the second control signaling, an indication of at least one uplink subband for the uplink signaling and at least one downlink subband for the downlink signaling corresponding to the one or more time intervals according to the full duplex mode.

In some examples, to support transmitting the uplink signaling and receiving the downlink signaling, the full duplex mode manager 835 is capable of, configured to, or operable to support a means for transmitting the uplink signaling via the one or more time intervals to the first cell or the first transmission reception point according to the first portion of the time duration pattern. In some examples, to support transmitting the uplink signaling and receiving the downlink signaling, the full duplex mode manager 835 is capable of, configured to, or operable to support a means for receiving the downlink signaling via the one or more time intervals from the second cell or the second transmission reception point according to the second portion of the time duration pattern.

In some examples, the first cell or the first transmission reception point is associated with a first component carrier of a carrier aggregation mode, and the second cell or the second transmission reception point is associated with a second component carrier of the carrier aggregation mode.

In some examples, the full duplex mode manager 835 is capable of, configured to, or operable to support a means for receiving, via the second control signaling, an indication that the full duplex mode applies to each of the one or more time intervals in a UE supported full duplex mode.

In some examples, the control signaling manager 845 is capable of, configured to, or operable to support a means for receiving a control message, where a first set of fields of the control message includes the first control signaling and a second set of fields of the control message includes the second control signaling.

In some examples, the control signaling manager 845 is capable of, configured to, or operable to support a means for receiving a first control message including the first control signaling. In some examples, the control signaling manager 845 is capable of, configured to, or operable to support a means for receiving a second control message including the second control signaling.

In some examples, the capability information manager 850 is capable of, configured to, or operable to support a means for transmitting capability information including an indication that the UE supports the full duplex mode at the UE side, where receiving the second control signaling is based on the capability information.

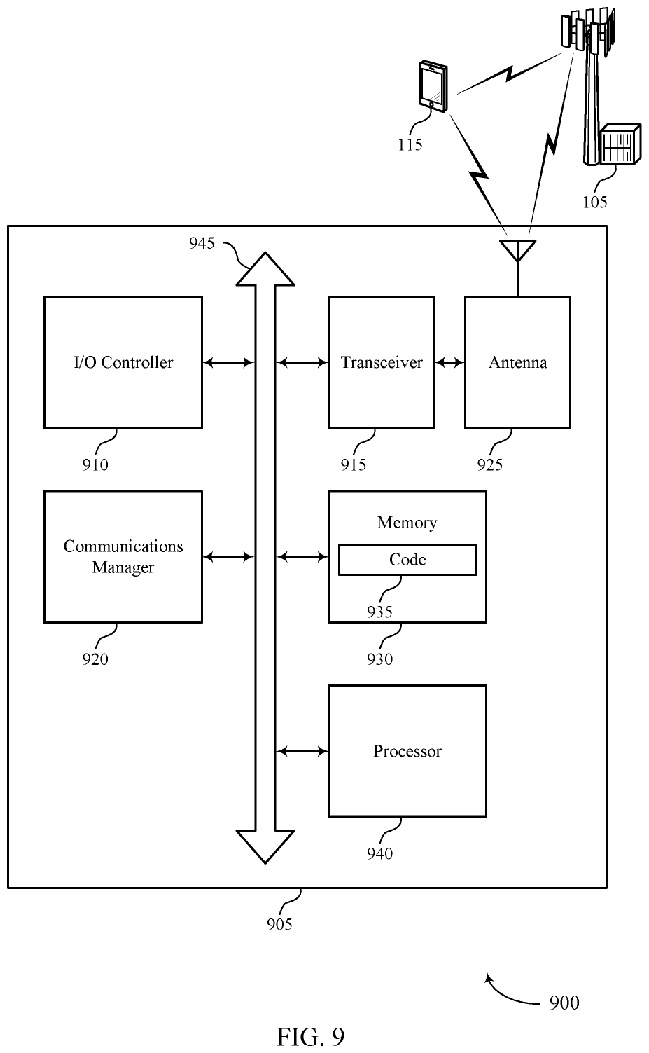

FIG. 9 shows a diagram of a system 900 including a device 905 that supports communications by a subband full duplex capable UE in a half duplex cell mode in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable code 935 including instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may contain, among other things, a basic I/O system (BIOS) which may control basic hardware or software operation such as the interaction with peripheral components or devices.

The at least one processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting communications by a subband full duplex capable UE in a half duplex cell mode). For example, the device 905 or a component of the device 905 may include at least one processor 940 and at least one memory 930 coupled with or to the at least one processor 940, the at least one processor 940 and at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. As such, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving first control signaling including an indication of a time duration pattern for wireless communication with a network via a set of multiple time intervals, the set of multiple time intervals including a first set of downlink time intervals, a second set of uplink time intervals, a third set of flexible time intervals, or any combination thereof. The communications manager 920 is capable of, configured to, or operable to support a means for receiving second control signaling designating one or more time intervals of the set of multiple time intervals for wireless communications by the UE according to a full duplex mode supported by the UE. The communications manager 920 is capable of, configured to, or operable to support a means for simultaneously transmitting uplink signaling and receiving downlink signaling via the one or more time intervals of the set of multiple time intervals according to the indication and according to the full duplex mode.

By including or configuring the communications manager 920 in accordance with examples as described herein, the device 905 may support techniques for communications by a subband full duplex capable UE resulting in more efficient use of available system resources, more reliable communications, increased throughput, improved coordination between devices, decreased system latency, and improved user experience.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of communications by a subband full duplex capable UE in a half duplex cell mode as described herein, or the at least one processor 940 and the at least one memory 930 may be otherwise configured to, individually or collectively, perform or support such operations.

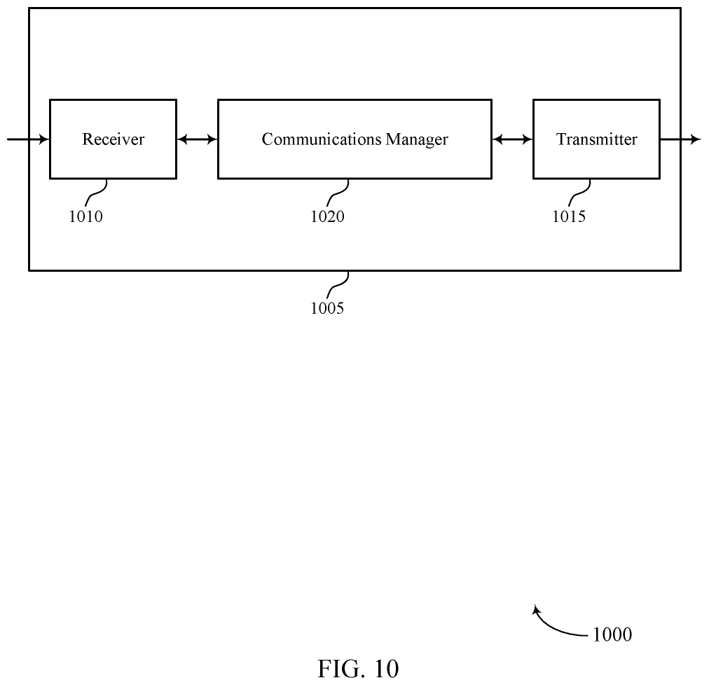

FIG. 10 shows a block diagram 1000 of a device 1005 that supports communications by a subband full duplex capable UE in a half duplex cell mode in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of communications by a subband full duplex capable UE in a half duplex cell mode as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting. individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor. If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for transmitting first control signaling including an indication of a time duration pattern for wireless communication with a UE via a set of multiple time intervals, the set of multiple time intervals including a first set of downlink time intervals, a second set of uplink time intervals, a third set of flexible time intervals, or any combination thereof. The communications manager 1020 is capable of, configured to, or operable to support a means for transmitting second control signaling designating one or more time intervals of the set of multiple time intervals for wireless communications by the UE according to a full duplex mode supported by the UE. The communications manager 1020 is capable of, configured to, or operable to support a means for receiving uplink signaling, or transmitting downlink signaling, or both simultaneously, via the one or more time intervals of the set of multiple time intervals according to the indication and according to the full duplex mode supported by the UE.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for communications by a subband full duplex capable UE resulting in more efficient use of available system resources, more reliable communications, decreased system latency, and improved user experience.

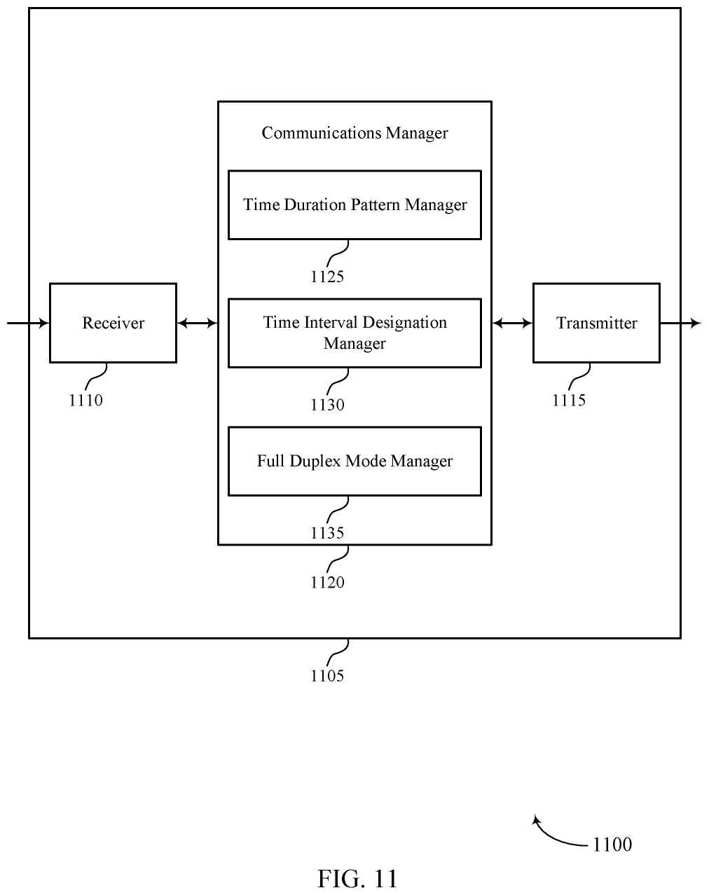

FIG. 11 shows a block diagram 1100 of a device 1105 that supports communications by a subband full duplex capable UE in a half duplex cell mode in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one of more components of the device 1105 (e.g., the receiver 1110, the transmitter 1115, and the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of communications by a subband full duplex capable UE in a half duplex cell mode as described herein. For example, the communications manager 1120 may include a time duration pattern manager 1125, a time interval designation manager 1130, a full duplex mode manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The time duration pattern manager 1125 is capable of, configured to, or operable to support a means for transmitting first control signaling including an indication of a time duration pattern for wireless communication with a UE via a set of multiple time intervals, the set of multiple time intervals including a first set of downlink time intervals, a second set of uplink time intervals, a third set of flexible time intervals, or any combination thereof. The time interval designation manager 1130 is capable of, configured to, or operable to support a means for transmitting second control signaling designating one or more time intervals of the set of multiple time intervals for wireless communications by the UE according to a full duplex mode supported by the UE. The full duplex mode manager 1135 is capable of, configured to, or operable to support a means for receiving uplink signaling, or transmitting downlink signaling, or both simultaneously, via the one or more time intervals of the set of multiple time intervals according to the indication and according to the full duplex mode supported by the UE.

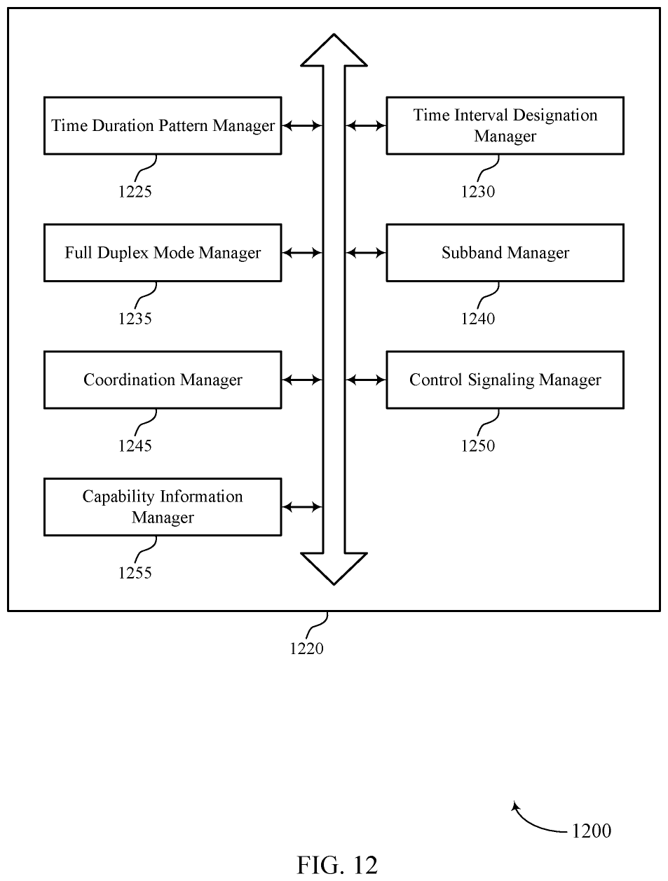

FIG. 12 shows a block diagram 1200 of a communications manager 1220 that supports communications by a subband full duplex capable UE in a half duplex cell mode in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of communications by a subband full duplex capable UE in a half duplex cell mode as described herein. For example, the communications manager 1220 may include a time duration pattern manager 1225, a time interval designation manager 1230, a full duplex mode manager 1235, a subband manager 1240, a coordination manager 1245, a control signaling manager 1250, a capability information manager 1255, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The time duration pattern manager 1225 is capable of, configured to, or operable to support a means for transmitting first control signaling including an indication of a time duration pattern for wireless communication with a UE via a set of multiple time intervals, the set of multiple time intervals including a first set of downlink time intervals, a second set of uplink time intervals, a third set of flexible time intervals, or any combination thereof. The time interval designation manager 1230 is capable of, configured to, or operable to support a means for transmitting second control signaling designating one or more time intervals of the set of multiple time intervals for wireless communications by the UE according to a full duplex mode supported by the UE. The full duplex mode manager 1235 is capable of, configured to, or operable to support a means for receiving uplink signaling, or transmitting downlink signaling, or both simultaneously, via the one or more time intervals of the set of multiple time intervals according to the indication and according to the full duplex mode supported by the UE.

In some examples, the subband manager 1240 is capable of, configured to, or operable to support a means for transmitting, via the second control signaling, an indication of at least one uplink subband and at least one downlink subband corresponding to the one or more time intervals according to the full duplex mode, where receiving the uplink signaling via the one or more time intervals is based on the indication of the at least one uplink subband, or transmitting the downlink signaling via the one or more time intervals is based on the indication of the at least one downlink subband.

In some examples, the second control signaling designates one or more uplink time intervals of the second set of uplink time intervals for the wireless communications by the UE according to the full duplex mode, and where the uplink signaling is transmitted via the at least one uplink subband during the designated one or more uplink time intervals and the downlink signaling is received via the at least one downlink subband during the designated one or more downlink time intervals.

In some examples, the second control signaling designates one or more downlink time intervals of the first set of downlink time intervals for the wireless communications by the UE according to the full duplex mode, and where the uplink signaling is transmitted via the at least one uplink subband during the designated one or more downlink time intervals and the downlink signaling is received via the at least one downlink subband during the designated one or more uplink time intervals.

In some examples, the second control signaling designates one or more flexible time intervals of the third set of flexible time intervals for the wireless communications by the UE according to the full duplex mode, and where the uplink signaling is transmitted via the at least one uplink subband during the designated one or more flexible time intervals and the downlink signaling is received via the at least one downlink subband during the designated one or more flexible time intervals.

In some examples, the full duplex mode supported by the UE includes a subband full duplex mode, or a partially overlapping full duplex mode, and where receiving the indication of the at least one uplink subband and the at least one downlink subband is based on the subband full duplex mode or the partially overlapping full duplex mode supported by the UE.

In some examples, the coordination manager 1245 is capable of, configured to, or operable to support a means for transmitting, via a communication link, a message to a second network entity indicating at least one time interval of the one or more time intervals, a directionality of the one or more time intervals, a first set of one or more frequency resources for the full duplex operation, or a combination thereof, per cell of a plurality of cells, per component carrier of a plurality of component carriers, per distributed unit of a plurality of distributed units, per central unit of a plurality of central units, or any combination thereof. In some examples, the coordination manager 1245 is capable of, configured to, or operable to support a means for receiving, via the communication link from the second network entity, a second message indicating at least a second time interval, a second directionality of the at least second time interval, a second set of one or more frequency resources for the full duplex operation, or a combination thereof, per cell of the plurality of cells, per component carrier of the plurality of component carriers, per distributed unit of the plurality of distributed units, per central unit of the plurality of central units, or any combination thereof. In some examples, the coordination manager 1245 is capable of, configured to, or operable to support a means for transmitting, via the second control signaling, an indication that the one or more time intervals correspond to the uplink signaling or the downlink signaling. where the other of either the uplink signaling or the downlink signaling during the one or more time intervals corresponds to the second time duration pattern.

In some examples, the communication link includes a backhaul link or an over-the-air link.

In some examples, the time duration pattern manager 1225 is capable of, configured to, or operable to support a means for transmitting, via the first control signaling, a first portion of the time duration pattern corresponding to a first cell or a first transmission reception point and a second portion of the time duration pattern corresponding to a second cell or a second transmission reception point. In some examples, the time duration pattern manager 1225 is capable of, configured to, or operable to support a means for transmitting, via the second control signaling, an indication of at least one uplink subband for the uplink signaling and at least one downlink subband for the downlink signaling corresponding to the one or more time intervals according to the full duplex mode.

In some examples, to support simultaneously receiving the uplink signaling and transmitting the downlink signaling, the time duration pattern manager 1225 is capable of, configured to, or operable to support a means for receiving the uplink signaling via the one or more time intervals according to the first portion of the time duration pattern. In some examples, to support simultaneously receiving the uplink signaling and transmitting the downlink signaling, the time duration pattern manager 1225 is capable of, configured to, or operable to support a means for transmitting the downlink signaling via the one or more time intervals according to the second portion of the time duration pattern.

In some examples, the first network entity is associated with a first component carrier of a carrier aggregation mode, and the second network entity is associated with a second component carrier of the carrier aggregation mode.

In some examples, the full duplex mode manager 1235 is capable of, configured to, or operable to support a means for transmitting, via the second control signaling, an indication that the full duplex mode applies to each of the one or more time intervals in a UE supported full duplex mode.

In some examples, the control signaling manager 1250 is capable of, configured to, or operable to support a means for transmitting a control message, where a first set of fields of the control message includes the first control signaling and a second set of fields of the control message includes the second control signaling.

In some examples, the control signaling manager 1250 is capable of, configured to, or operable to support a means for transmitting a first control message including the first control signaling. In some examples, the control signaling manager 1250 is capable of, configured to, or operable to support a means for transmitting a second control message including the second control signaling.

In some examples, the capability information manager 1255 is capable of, configured to, or operable to support a means for receiving capability information including an indication that the UE supports the full duplex mode, where transmitting the second control signaling is based on the capability information.

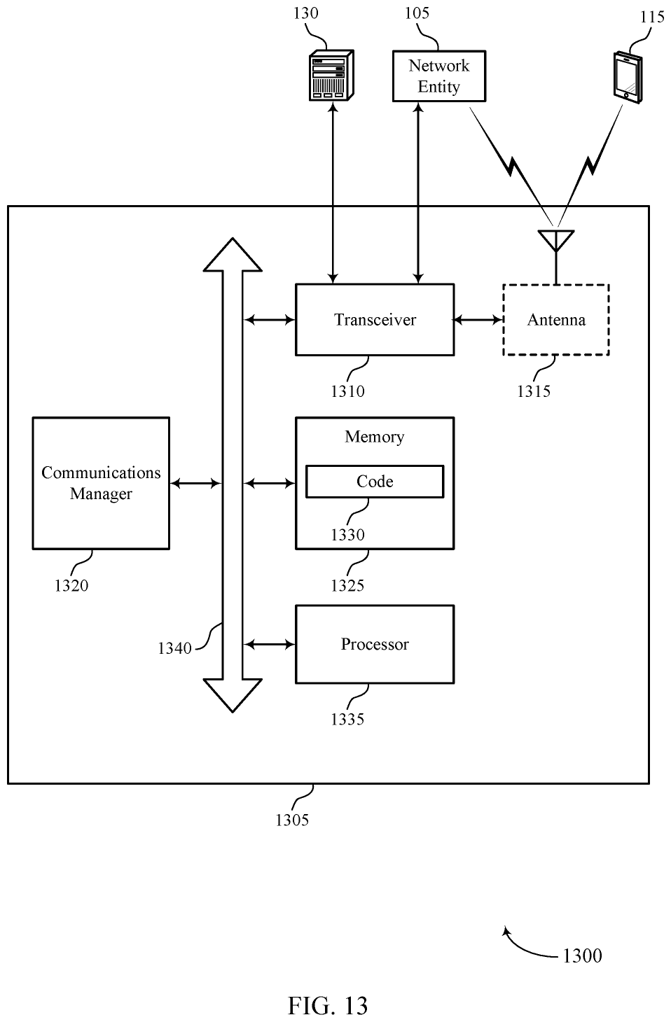

FIG. 13 shows a diagram of a system 1300 including a device 1305 that supports communications by a subband full duplex capable UE in a half duplex cell mode in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., a communication link 125, a backhaul communication link 120, a midhaul communication link 162, a fronthaul communication link 168).

The at least one memory 1325 may include RAM, ROM, or any combination thereof. The at least one memory 1325 may store computer-readable, computer-executable code 1330 including instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may contain, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting communications by a subband full duplex capable UE in a half duplex cell mode). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325). In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. As such, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for transmitting first control signaling including an indication of a time duration pattern for wireless communication with a UE via a set of multiple time intervals, the set of multiple time intervals including a first set of downlink time intervals, a second set of uplink time intervals, a third set of flexible time intervals, or any combination thereof. The communications manager 1320 is capable of, configured to, or operable to support a means for transmitting second control signaling designating one or more time intervals of the set of multiple time intervals for wireless communications by the UE according to a full duplex mode supported by the UE. The communications manager 1320 is capable of, configured to, or operable to support a means for receiving uplink signaling, or transmitting downlink signaling, or both simultaneously, via the one or more time intervals of the set of multiple time intervals according to the indication and according to the full duplex mode supported by the UE.

By including or configuring the communications manager 1320 in accordance with examples as described herein, the device 1305 may support techniques for communications by a subband full duplex capable UE resulting in more efficient use of available system resources, more reliable communications, increased throughput, improved coordination between devices, decreased system latency, and improved user experience.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of communications by a subband full duplex capable UE in a half duplex cell mode as described herein, or the at least one processor 1335 and the at least one memory 1325 may be otherwise configured to, individually or collectively, perform or support such operations.

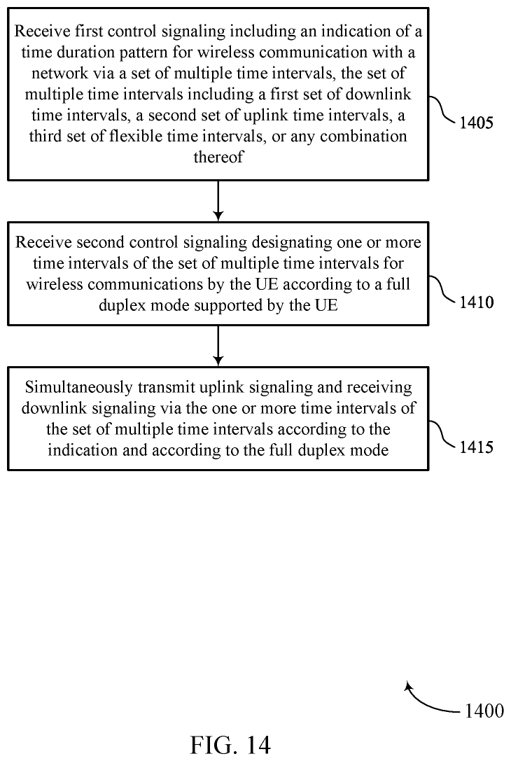

FIG. 14 shows a flowchart illustrating a method 1400 that supports communications by a subband full duplex capable UE in a half duplex cell mode in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving first control signaling including an indication of a time duration pattern for wireless communication with a network via a set of multiple time intervals, the set of multiple time intervals including a first set of downlink time intervals, a second set of uplink time intervals, a third set of flexible time intervals, or any combination thereof. The operations of block 1405 may be performed in accordance with examples as disclosed herein. In some examples, aspects of the operations of 1405 may be performed by a time duration pattern manager 825 as described with reference to FIG. 8.

At 1410, the method may include receiving second control signaling designating one or more time intervals of the set of multiple time intervals for wireless communications by the UE according to a full duplex mode supported by the UE. The operations of block 1410 may be performed in accordance with examples as disclosed herein. In some examples, aspects of the operations of 1410 may be performed by a time interval designation manager 830 as described with reference to FIG. 8.

At 1415, the method may include simultaneously transmitting uplink signaling and receiving downlink signaling via the one or more time intervals of the set of multiple time intervals according to the indication and according to the full duplex mode. The operations of block 1415 may be performed in accordance with examples as disclosed herein. In some examples, aspects of the operations of 1415 may be performed by a full duplex mode manager 835 as described with reference to FIG. 8.

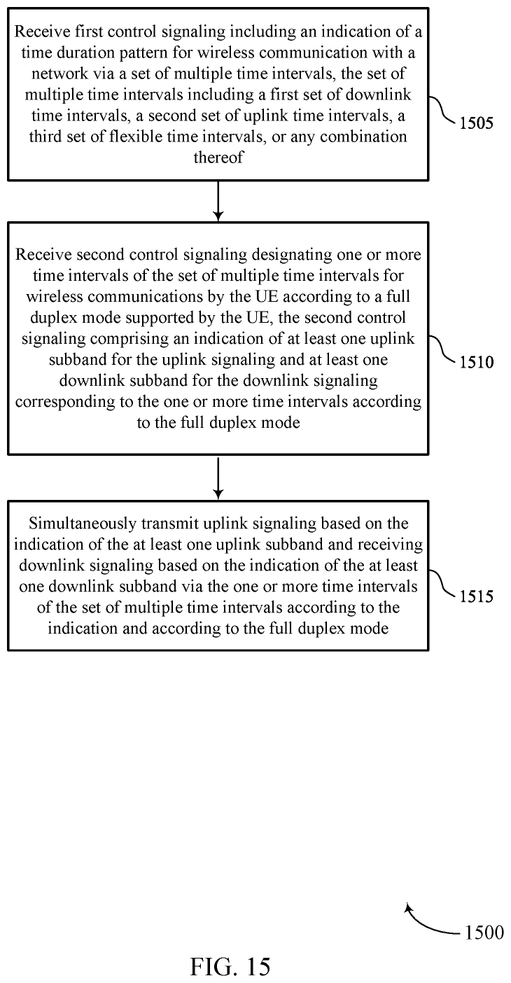

FIG. 15 shows a flowchart illustrating a method 1500 that supports communications by a subband full duplex capable UE in a half duplex cell mode in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving first control signaling including an indication of a time duration pattern for wireless communication with a network via a set of multiple time intervals, the set of multiple time intervals including a first set of downlink time intervals, a second set of uplink time intervals, a third set of flexible time intervals, or any combination thereof. The operations of block 1505 may be performed in accordance with examples as disclosed herein. In some examples, aspects of the operations of 1505 may be performed by a time duration pattern manager 825 as described with reference to FIG. 8.

At 1510, the method may include receiving second control signaling designating one or more time intervals of the set of multiple time intervals for wireless communications by the UE according to a full duplex mode supported by the UE, the second control signaling comprising an indication of at least one uplink subband for the uplink signaling and at least one downlink subband for the downlink signaling corresponding to the one or more time intervals according to the full duplex mode. The operations of block 1510 may be performed in accordance with examples as disclosed herein. In some examples, aspects of the operations of 1510 may be performed by a time interval designation manager 830 as described with reference to FIG. 8.

At 1515, the method may include simultaneously transmit uplink signaling based on the indication of the at least one uplink subband and receiving downlink signaling based on the indication of the at least one downlink subband via the one or more time intervals of the set of multiple time intervals according to the indication and according to the full duplex mode. The operations of block 1515 may be performed in accordance with examples as disclosed herein. In some examples, aspects of the operations of 1515 may be performed by a full duplex mode manager 835 as described with reference to FIG. 8.

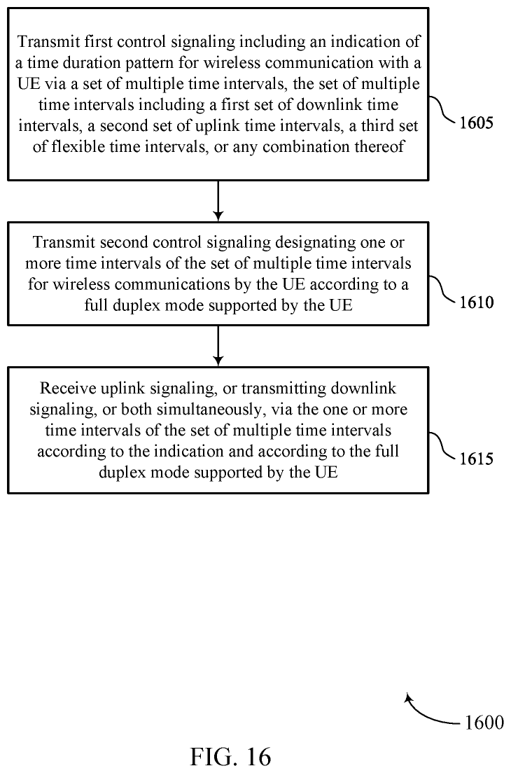

FIG. 16 shows a flowchart illustrating a method 1600 that supports communications by a subband full duplex capable UE in a half duplex cell mode in accordance with aspects of the present disclosure. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1605, the method may include transmitting first control signaling including an indication of a time duration pattern for wireless communication with a UE via a set of multiple time intervals, the set of multiple time intervals including a first set of downlink time intervals, a second set of uplink time intervals, a third set of flexible time intervals, or any combination thereof. The operations of block 1605 may be performed in accordance with examples as disclosed herein. In some examples, aspects of the operations of 1605 may be performed by a time duration pattern manager 1225 as described with reference to FIG. 12.

At 1610, the method may include transmitting second control signaling designating one or more time intervals of the set of multiple time intervals for wireless communications by the UE according to a full duplex mode supported by the UE. The operations of block 1610 may be performed in accordance with examples as disclosed herein. In some examples, aspects of the operations of 1610 may be performed by a time interval designation manager 1230 as described with reference to FIG. 12.

At 1615, the method may include receiving uplink signaling, or transmitting downlink signaling, or both simultaneously, via the one or more time intervals of the set of multiple time intervals according to the indication and according to the full duplex mode supported by the UE. The operations of block 1615 may be performed in accordance with examples as disclosed herein. In some examples, aspects of the operations of 1615 may be performed by a full duplex mode manager 1235 as described with reference to FIG. 12.

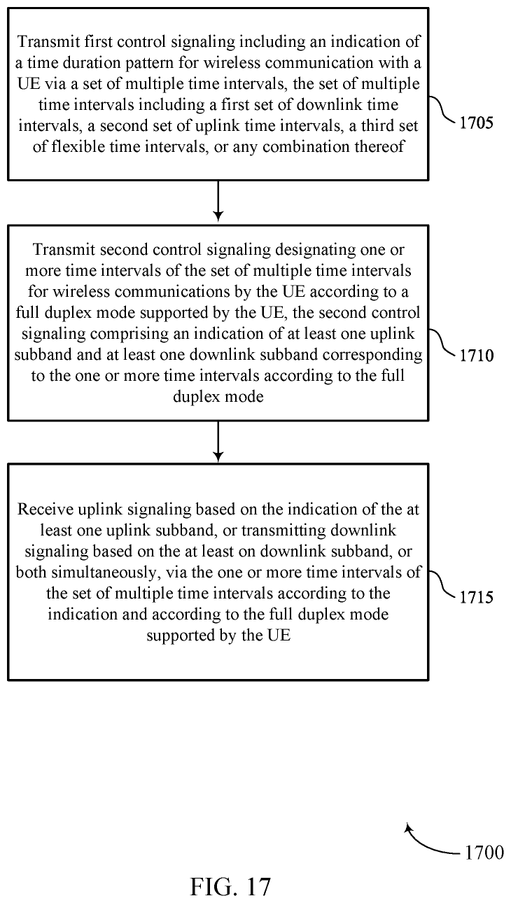

FIG. 17 shows a flowchart illustrating a method 1700 that supports communications by a subband full duplex capable UE in a half duplex cell mode in accordance with aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include transmitting first control signaling including an indication of a time duration pattern for wireless communication with a UE via a set of multiple time intervals, the set of multiple time intervals including a first set of downlink time intervals, a second set of uplink time intervals, a third set of flexible time intervals, or any combination thereof. The operations of block 1705 may be performed in accordance with examples as disclosed herein. In some examples, aspects of the operations of 1705 may be performed by a time duration pattern manager 1225 as described with reference to FIG. 12.

At 1710, the method may include transmitting second control signaling designating one or more time intervals of the set of multiple time intervals for wireless communications by the UE according to a full duplex mode supported by the UE, the second control signaling comprising an indication of at least one uplink subband and at least one downlink subband corresponding to the one or more time intervals according to the full duplex mode. The operations of block 1710 may be performed in accordance with examples as disclosed herein. In some examples, aspects of the operations of 1710 may be performed by a time interval designation manager 1230 as described with reference to FIG. 12.

At 1715, the method may include receiving uplink signaling based on the indication of the at least one uplink subband, or transmitting downlink signaling based on the at least on downlink subband, or both simultaneously, via the one or more time intervals of the set of multiple time intervals according to the indication and according to the full duplex mode supported by the UE. The operations of block 1715 may be performed in accordance with examples as disclosed herein. In some examples, aspects of the operations of 1715 may be performed by a full duplex mode manager 1235 as described with reference to FIG. 12.

The following provides an overview of aspects of the present disclosure:

Aspect 1: A method for wireless communications at a UE, comprising: receiving first control signaling comprising an indication of a time duration pattern for wireless communication with a network via a plurality of time intervals, the plurality of time intervals comprising a first set of downlink time intervals, a second set of uplink time intervals, a third set of flexible time intervals, or any combination thereof; receiving second control signaling designating one or more time intervals of the plurality of time intervals for wireless communications by the UE according to a full duplex mode supported by the UE; and simultaneously transmitting uplink signaling and receiving downlink signaling via the one or more time intervals of the plurality of time intervals according to the indication and according to the full duplex mode.

Aspect 2: The method of aspect 1, further comprising: receiving, via the second control signaling, an indication of at least one uplink subband for the uplink signaling and at least one downlink subband for the downlink signaling corresponding to the one or more time intervals according to the full duplex mode, wherein transmitting the uplink signaling via the one or more time intervals is based at least in part on the indication of the at least one uplink subband, and receiving the downlink signaling via the one or more time intervals is based at least in part on the indication of the at least one downlink subband.

Aspect 3: The method of aspect 2, wherein the second control signaling designates one or more downlink time intervals of the first set of downlink time intervals for the wireless communications by the UE according to the full duplex mode, and wherein the uplink signaling is transmitted via the at least one uplink subband during the designated one or more downlink time intervals and the downlink signaling is received via the at least one downlink subband during the designated one or more uplink time intervals.

Aspect 4: The method of any of aspects 2 through 3, wherein the second control signaling designates one or more uplink time intervals of the second set of uplink time intervals for the wireless communications by the UE according to the full duplex mode, and wherein the uplink signaling is transmitted via the at least one uplink subband during the designated one or more uplink time intervals and the downlink signaling is received via the at least one downlink subband during the designated one or more downlink time intervals.

Aspect 5: The method of any of aspects 2 through 4, wherein the second control signaling designates one or more flexible time intervals of the third set of flexible time intervals for the wireless communications by the UE according to the full duplex mode, and wherein the uplink signaling is transmitted via the at least one uplink subband during the designated one or more flexible time intervals and the downlink signaling is received via the at least one downlink subband during the designated one or more flexible time intervals.

Aspect 6: The method of any of aspects 2 through 5, wherein the full duplex mode supported by the UE comprises a subband full duplex mode, or a partially overlapping full duplex mode, and wherein receiving the indication of the at least one uplink subband and the at least one downlink subband is based at least in part on the subband full duplex mode or the partially overlapping full duplex mode supported by the UE.

Aspect 7: The method of any of aspects 1 through 6, further comprising: receiving, via the first control signaling, a first portion of the time duration pattern corresponding to a first cell or a first transmission reception point and a second portion of the time duration pattern corresponding to a second cell or a second transmission reception point; and receiving, via the second control signaling, an indication of at least one uplink subband for the uplink signaling and at least one downlink subband for the downlink signaling corresponding to the one or more time intervals according to the full duplex mode.

Aspect 8: The method of aspect 7, wherein transmitting the uplink signaling and receiving the downlink signaling comprises: transmitting the uplink signaling via the one or more time intervals to the first cell or the first transmission reception point according to the first portion of the time duration pattern; and receiving the downlink signaling via the one or more time intervals from the second cell or the second transmission reception point according to the second portion of the time duration pattern.

Aspect 9: The method of any of aspects 7 through 8, wherein the first cell or the first transmission reception point is associated with a first component carrier of a carrier aggregation mode, and the second cell or the second transmission reception point is associated with a second component carrier of the carrier aggregation mode.

Aspect 10: The method of any of aspects 1 through 9, further comprising: receiving, via the second control signaling, an indication that the full duplex mode applies to each of the one or more time intervals in a UE supported full duplex mode.

Aspect 11: The method of any of aspects 1 through 10, further comprising: receiving a control message, wherein a first set of fields of the control message comprises the first control signaling and a second set of fields of the control message comprises the second control signaling.

Aspect 12: The method of any of aspects 1 through 11, further comprising: receiving a first control message comprising the first control signaling; and receiving a second control message comprising the second control signaling.

Aspect 13: The method of any of aspects 1 through 12, further comprising: transmitting capability information comprising an indication that the UE supports the full duplex mode at the UE side, wherein receiving the second control signaling is based at least in part on the capability information.

Aspect 14: A method for wireless communications at a network entity, comprising: transmitting first control signaling comprising an indication of a time duration pattern for wireless communication with a UE via a plurality of time intervals, the plurality of time intervals comprising a first set of downlink time intervals, a second set of uplink time intervals, a third set of flexible time intervals, or any combination thereof; transmitting second control signaling designating one or more time intervals of the plurality of time intervals for wireless communications by the UE according to a full duplex mode supported by the UE; and receiving uplink signaling, or transmitting downlink signaling, or both simultaneously, via the one or more time intervals of the plurality of time intervals according to the indication and according to the full duplex mode supported by the UE.

Aspect 15: The method of aspect 14, further comprising: transmitting, via the second control signaling, an indication of at least one uplink subband and at least one downlink subband corresponding to the one or more time intervals according to the full duplex mode, wherein receiving the uplink signaling via the one or more time intervals is based at least in part on the indication of the at least one uplink subband, or transmitting the downlink signaling via the one or more time intervals is based at least in part on the indication of the at least one downlink subband.

Aspect 16: The method of aspect 15, wherein the second control signaling designates one or more uplink time intervals of the second set of uplink time intervals for the wireless communications by the UE according to the full duplex mode, and wherein the uplink signaling is transmitted via the at least one uplink subband during the designated one or more uplink time intervals and the downlink signaling is received via the at least one downlink subband during the designated one or more downlink time intervals.

Aspect 17: The method of any of aspects 15 through 16, wherein the second control signaling designates one or more downlink time intervals of the first set of downlink time intervals for the wireless communications by the UE according to the full duplex mode, and wherein the uplink signaling is transmitted via the at least one uplink subband during the designated one or more downlink time intervals and the downlink signaling is received via the at least one downlink subband during the designated one or more uplink time intervals.

Aspect 18: The method of any of aspects 15 through 17, wherein the second control signaling designates one or more flexible time intervals of the third set of flexible time intervals for the wireless communications by the UE according to the full duplex mode, and wherein the uplink signaling is transmitted via the at least one uplink subband during the designated one or more flexible time intervals and the downlink signaling is received via the at least one downlink subband during the designated one or more flexible time intervals.

Aspect 19: The method of any of aspects 15 through 18, wherein the full duplex mode supported by the UE comprises a subband full duplex mode, or a partially overlapping full duplex mode, and wherein receiving the indication of the at least one uplink subband and the at least one downlink subband is based at least in part on the subband full duplex mode or the partially overlapping full duplex mode supported by the UE.

Aspect 20: The method of any of aspects 14 through 19, further comprising: transmitting, via a communication link, a message to a second network entity indicating at least one time interval of the one or more time intervals, a directionality of the one or more time intervals, a first set of one or more frequency resources for the full duplex operation, or a combination thereof, per cell of a plurality of cells, per component carrier of a plurality of component carriers, per distributed unit of a plurality of distributed units, per central unit of a plurality of central units, or any combination thereof; receiving, via the communication link from the second network entity, a second message indicating at least a second time interval, a second directionality of the at least second time interval, a second set of one or more frequency resources for the full duplex operation, or a combination thereof, per cell of the plurality of cells, per component carrier of the plurality of component carriers, per distributed unit of the plurality of distributed units, per central unit of the plurality of central units, or any combination thereof; and transmitting, via the second control signaling, an indication that the one or more time intervals correspond to the uplink signaling or the downlink signaling based at least in part on the message, the second message, or both.

Aspect 21: The method of aspect 20, wherein the communication link comprises a backhaul link or an over-the-air link.

Aspect 22: The method of any of aspects 14 through 21, further comprising: transmitting, via the first control signaling, a first portion of the time duration pattern corresponding to a first cell or a first transmission reception point and a second portion of the time duration pattern corresponding to a second cell or a second transmission reception point; and transmitting, via the second control signaling, an indication of at least one uplink subband for the uplink signaling and at least one downlink subband for the downlink signaling corresponding to the one or more time intervals according to the full duplex mode.

Aspect 23: The method of aspect 22, wherein simultaneously receiving the uplink signaling and transmitting the downlink signaling comprises: receiving the uplink signaling via the one or more time intervals according to the first portion of the time duration pattern; and transmitting the downlink signaling via the one or more time intervals according to the second portion of the time duration pattern.

Aspect 24: The method of any of aspects 22 through 23, wherein the first network entity is associated with a first component carrier of a carrier aggregation mode, and the second network entity is associated with a second component carrier of the carrier aggregation mode.

Aspect 25: The method of any of aspects 14 through 24, further comprising: transmitting, via the second control signaling, an indication that the full duplex mode applies to each of the one or more time intervals in a UE supported full duplex mode.

Aspect 26: The method of any of aspects 14 through 25, further comprising: transmitting a control message, wherein a first set of fields of the control message comprises the first control signaling and a second set of fields of the control message comprises the second control signaling.

Aspect 27: The method of any of aspects 14 through 26, further comprising: transmitting a first control message comprising the first control signaling; and transmitting a second control message comprising the second control signaling.

Aspect 28: The method of any of aspects 14 through 27, further comprising: receiving capability information comprising an indication that the UE supports the full duplex mode, wherein transmitting the second control signaling is based at least in part on the capability information.

Aspect 29: A UE for wireless communications, comprising one or more memories storing processor-executable code, and one or more processors coupled with the one or more memories and individually or collectively operable to execute the code to cause the UE to perform a method of any of aspects 1 through 13.

Aspect 30: A UE for wireless communications, comprising at least one means for performing a method of any of aspects 1 through 13.

Aspect 31: A non-transitory computer-readable medium storing code for wireless communications, the code comprising instructions executable by a processor to perform a method of any of aspects 1 through 13.

Aspect 32: A network entity for wireless communications, comprising one or more memories storing processor-executable code, and one or more processors coupled with the one or more memories and individually or collectively operable to execute the code to cause the network entity to perform a method of any of aspects 14 through 28.

Aspect 33: A network entity for wireless communications, comprising at least one means for performing a method of any of aspects 14 through 28.

Aspect 34: A non-transitory computer-readable medium storing code for wireless communications, the code comprising instructions executable by a processor to perform a method of any of aspects 14 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive first control signaling comprising an indication of a time duration pattern for wireless communication with a network via a plurality of time intervals, the plurality of time intervals comprising a first set of downlink time intervals, a second set of uplink time intervals, a third set of flexible time intervals, or any combination thereof;
receive second control signaling designating one or more time intervals of the plurality of time intervals for wireless communications by the UE according to a full duplex mode supported by the UE; and
simultaneously transmit uplink signaling and receiving downlink signaling via the one or more time intervals of the plurality of time intervals according to the indication and according to the full duplex mode.

2. The UE of claim 1, wherein the one or more processors are individually or collectively further operable to execute the code to cause the UE to:
receive, via the second control signaling, an indication of at least one uplink subband for the uplink signaling and at least one downlink subband for the downlink signaling corresponding to the one or more time intervals according to the full duplex mode, wherein transmitting the uplink signaling via the one or more time intervals is based at least in part on the indication of the at least one uplink subband, and receiving the downlink signaling via the one or more time intervals is based at least in part on the indication of the at least one downlink subband.

3. The UE of claim 2, wherein the second control signaling designates one or more downlink time intervals of the first set of downlink time intervals for the wireless communications by the UE according to the full duplex mode, and wherein the uplink signaling is transmitted via the at least one uplink subband during the designated one or more downlink time intervals and the downlink signaling is received via the at least one downlink subband during the designated one or more uplink time intervals.

4. The UE of claim 2, wherein the second control signaling designates one or more uplink time intervals of the second set of uplink time intervals for the wireless communications by the UE according to the full duplex mode, and wherein the uplink signaling is transmitted via the at least one uplink subband during the designated one or more uplink time intervals and the downlink signaling is received via the at least one downlink subband during the designated one or more downlink time intervals.

5. The UE of claim 2, wherein the second control signaling designates one or more flexible time intervals of the third set of flexible time intervals for the wireless communications by the UE according to the full duplex mode, and wherein the uplink signaling is transmitted via the at least one uplink subband during the designated one or more flexible time intervals and the downlink signaling is received via the at least one downlink subband during the designated one or more flexible time intervals.

6. The UE of claim 2, wherein the full duplex mode supported by the UE comprises a subband full duplex mode, or a partially overlapping full duplex mode, and wherein receiving the indication of the at least one uplink subband and the at least one downlink subband is based at least in part on the subband full duplex mode or the partially overlapping full duplex mode supported by the UE.

7. The UE of claim 1, wherein the one or more processors are individually or collectively further operable to execute the code to cause the UE to:
receive, via the first control signaling, a first portion of the time duration pattern corresponding to a first cell or a first transmission reception point and a second portion of the time duration pattern corresponding to a second cell or a second transmission reception point; and
receive, via the second control signaling, an indication of at least one uplink subband for the uplink signaling and at least one downlink subband for the downlink signaling corresponding to the one or more time intervals according to the full duplex mode.

8. The UE of claim 7, wherein, to transmit the uplink signaling and receiving the downlink signaling, the one or more processors are individually or collectively operable to execute the code to cause the UE to:
transmit the uplink signaling via the one or more time intervals to the first cell or the first transmission reception point according to the first portion of the time duration pattern; and
receive the downlink signaling via the one or more time intervals from the second cell or the second transmission reception point according to the second portion of the time duration pattern.

9. The UE of claim 7, wherein the first cell or the first transmission reception point is associated with a first component carrier of a carrier aggregation mode, and the second cell or the second transmission reception point is associated with a second component carrier of the carrier aggregation mode.

10. The UE of claim 1, wherein the one or more processors are individually or collectively further operable to execute the code to cause the UE to:
receive, via the second control signaling, an indication that the full duplex mode applies to each of the one or more time intervals in a UE supported full duplex mode.

11. The UE of claim 1, wherein the one or more processors are individually or collectively further operable to execute the code to cause the UE to:
receive a control message, wherein a first set of fields of the control message comprises the first control signaling and a second set of fields of the control message comprises the second control signaling.

12. The UE of claim 1, wherein the one or more processors are individually or collectively further operable to execute the code to cause the UE to:
receive a first control message comprising the first control signaling; and
receive a second control message comprising the second control signaling.

13. The UE of claim 1, wherein the one or more processors are individually or collectively further operable to execute the code to cause the UE to:
transmit capability information comprising an indication that the UE supports the full duplex mode at the UE side, wherein receiving the second control signaling is based at least in part on the capability information.

14. A network entity, comprising:
one or more memories storing processor-executable code; and
one or more processors coupled with the one or more memories and individually or collectively operable to execute the code to cause the network entity to:
transmit first control signaling comprising an indication of a time duration pattern for wireless communication with a user equipment (UE) via a plurality of time intervals, the plurality of time intervals comprising a first set of downlink time intervals, a second set of uplink time intervals, a third set of flexible time intervals, or any combination thereof;
transmit second control signaling designating one or more time intervals of the plurality of time intervals for wireless communications by the UE according to a full duplex mode supported by the UE; and
receive uplink signaling, or transmitting downlink signaling, or both simultaneously, via the one or more time intervals of the plurality of time intervals according to the indication and according to the full duplex mode supported by the UE.

15. The network entity of claim 14, wherein the one or more processors are individually or collectively further operable to execute the code to cause the network entity to:
transmit, via the second control signaling, an indication of at least one uplink subband and at least one downlink subband corresponding to the one or more time intervals according to the full duplex mode, wherein receiving the uplink signaling via the one or more time intervals is based at least in part on the indication of the at least one uplink subband, or transmitting the downlink signaling via the one or more time intervals is based at least in part on the indication of the at least one downlink subband.

16. The network entity of claim 15, wherein the second control signaling designates one or more uplink time intervals of the second set of uplink time intervals for the wireless communications by the UE according to the full duplex mode, and wherein the uplink signaling is transmitted via the at least one uplink subband during the designated one or more uplink time intervals and the downlink signaling is received via the at least one downlink subband during the designated one or more downlink time intervals.

17. The network entity of claim 15, wherein the second control signaling designates one or more downlink time intervals of the first set of downlink time intervals for the wireless communications by the UE according to the full duplex mode, and wherein the uplink signaling is transmitted via the at least one uplink subband during the designated one or more downlink time intervals and the downlink signaling is received via the at least one downlink subband during the designated one or more uplink time intervals.

18. The network entity of claim 15, wherein the second control signaling designates one or more flexible time intervals of the third set of flexible time intervals for the wireless communications by the UE according to the full duplex mode, and wherein the uplink signaling is transmitted via the at least one uplink subband during the designated one or more flexible time intervals and the downlink signaling is received via the at least one downlink subband during the designated one or more flexible time intervals.

19. The network entity of claim 15, wherein the full duplex mode supported by the UE comprises a subband full duplex mode, or a partially overlapping full duplex mode, and wherein receiving the indication of the at least one uplink subband and the at least one downlink subband is based at least in part on the subband full duplex mode or the partially overlapping full duplex mode supported by the UE.

20. The network entity of claim 14, wherein the one or more processors are individually or collectively further operable to execute the code to cause the network entity to:
transmit, via a communication link, a message to a second network entity indicating at least one time interval of the one or more time intervals, a directionality of the one or more time intervals, a first set of one or more frequency resources for the full duplex operation, or a combination thereof, per cell of a plurality of cells, per component carrier of a plurality of component carriers, per distributed unit of a plurality of distributed units, per central unit of a plurality of central units, or any combination thereof;
receive, via the communication link from the second network entity, a second message indicating at least a second time interval, a second directionality of the at least second time interval, a second set of one or more frequency resources for the full duplex operation, or a combination thereof, per cell of the plurality of cells, per component carrier of the plurality of component carriers, per distributed unit of the plurality of distributed units, per central unit of the plurality of central units, or any combination thereof; and
transmit, via the second control signaling, an indication that the one or more time intervals correspond to the uplink signaling or the downlink signaling based at least in part on the message, the second message, or both.

21. The network entity of claim 20, wherein the communication link comprises a backhaul link or an over-the-air link.

22. The network entity of claim 14, wherein the one or more processors are individually or collectively further operable to execute the code to cause the network entity to:
transmit, via the first control signaling, a first portion of the time duration pattern corresponding to a first cell or a first transmission reception point and a second portion of the time duration pattern corresponding to a second cell or a second transmission reception point; and
transmit, via the second control signaling, an indication of at least one uplink subband for the uplink signaling and at least one downlink subband for the downlink signaling corresponding to the one or more time intervals according to the full duplex mode.

23. The network entity of claim 22, wherein, to simultaneously receive the uplink signaling and transmitting the downlink signaling, the one or more processors are individually or collectively operable to execute the code to cause the network entity to:
receive the uplink signaling via the one or more time intervals according to the first portion of the time duration pattern; and
transmit the downlink signaling via the one or more time intervals according to the second portion of the time duration pattern.

24. The network entity of claim 22, wherein the first network entity is associated with a first component carrier of a carrier aggregation mode, and the second network entity is associated with a second component carrier of the carrier aggregation mode.

25. The network entity of claim 14, wherein the one or more processors are individually or collectively further operable to execute the code to cause the network entity to:
transmit, via the second control signaling, an indication that the full duplex mode applies to each of the one or more time intervals in a UE supported full duplex mode.

26. The network entity of claim 14, wherein the one or more processors are individually or collectively further operable to execute the code to cause the network entity to:
transmit a control message, wherein a first set of fields of the control message comprises the first control signaling and a second set of fields of the control message comprises the second control signaling.

27. The network entity of claim 14, wherein the one or more processors are individually or collectively further operable to execute the code to cause the network entity to:
transmit a first control message comprising the first control signaling; and
transmit a second control message comprising the second control signaling.

28. The network entity of claim 14, wherein the one or more processors are individually or collectively further operable to execute the code to cause the network entity to:
receive capability information comprising an indication that the UE supports the full duplex mode, wherein transmitting the second control signaling is based at least in part on the capability information.

29. A method for wireless communications at a user equipment (UE), comprising:
receiving first control signaling comprising an indication of a time duration pattern for wireless communication with a network via a plurality of time intervals, the plurality of time intervals comprising a first set of downlink time intervals, a second set of uplink time intervals, a third set of flexible time intervals, or any combination thereof;
receiving second control signaling designating one or more time intervals of the plurality of time intervals for wireless communications by the UE according to a full duplex mode supported by the UE; and
simultaneously transmitting uplink signaling and receiving downlink signaling via the one or more time intervals of the plurality of time intervals according to the indication and according to the full duplex mode.

30. A method for wireless communications at a network entity, comprising:
transmitting first control signaling comprising an indication of a time duration pattern for wireless communication with a user equipment (UE) via a plurality of time intervals, the plurality of time intervals comprising a first set of downlink time intervals, a second set of uplink time intervals, a third set of flexible time intervals, or any combination thereof;
transmitting second control signaling designating one or more time intervals of the plurality of time intervals for wireless communications by the UE according to a full duplex mode supported by the UE; and
receiving uplink signaling. or transmitting downlink signaling. or both simultaneously, via the one or more time intervals of the plurality of time intervals according to the indication and according to the full duplex mode supported by the UE.
